(19) United States
(12) Patent Application Publication
(10) Pub. No.: US 2012/0215458 A1
(43) Pub. Date: Aug. 23, 2012

(54) Orthologous Phenotypes and Non-Obvious Human Disease Models

(75) Inventors: Edward Marcotte, Austin, TX (US); Kriston McGary, Brentwood, TN (US); John Wallingford, Austin, TX (US); Tae Joo Park, Ulsan Metropolitan City (KR); John O. Woods, Austin, TX (US); Hye Ji Cha, Austin, TX (US)

(73) Assignee: Board of Regents, The University of Texas System, Austin, TX (US)

(21) Appl. No.: 13/383,916

(22) PCT Filed: Jul. 13, 2010
(86) PCT No.: PCT/US10/41840

§ 371 Date: May 4, 2012

Related U.S. Application Data
(60) Provisional application No. 61/225,427, filed on Jul. 14, 2009.

(51) Int. Cl. G06F 19/18; G06G 7/60; G06F 17/10; G06F 19/24

(52) U.S. Cl. 702/19; 703/11; 703/2

(57) ABSTRACT

A method for the quantification of equivalence between mutational phenotypes to develop non-obvious human disease models is described herein. The present inventors discover candidate genes for diseases of interest by: first, identifying orthologous phenotypes (called phenologs) involving the phenotype of interest (the first phenotype), in which a set of genes is associated with the first phenotype in the first organism, a set of genes is associated with a second phenotype in a second organism, the first and second phenotypes not having one or more common characteristics, and the second phenotype is selected such that at least one gene belongs to both the first and second phenotype gene sets; second, selecting from the second organism one or more second phenotype genes, other than the genes known to overlap the first and second phenotypes, as candidates for also belonging to the first phenotype in the first organism.

### TECHNICAL FIELD OF THE INVENTION

The present invention relates in general to the field of mutational phenotypes, and more particularly, to the quantification of equivalence between mutational phenotypes in order to associate new genes with traits and to develop non-obvious human disease models.

### BACKGROUND ART

Without limiting the scope of the invention, its background is described in connection with the analysis of high-throughput functional genomics data in other species to shed light on human diseases. United States Patent Application No. 20090087846 (Radtkey, et al., 2009) describes a method for querying biological samples to detect genetic mutations, particularly insertions and deletions, by co-amplification of a gene of interest in conjunction with a paralogous gene. When the gene of interest and the corresponding paralogous gene are selected from the CYP450 family, the resulting ratios may predict how a particular patient metabolizes certain prescription drugs.

U.S. Pat. No. 7,324,928 issued to Kitchen and Kitchen, 2008 describes a method and system for determining phenotype from genotype. The '928 patent teaches a method and system for deriving an outcome predictor for a data set in which a number of complex variables affect outcome. A two step model is applied that includes application of 1) a flexible nonparametric tool for modeling complex data, and 2) a recursive partitioning (e.g., classification and regression trees) methodology. In one variation, a determination is made as to whether the data set used is representative of a population of interest; if not, underrepresented data is replicated so as to produce a representative data set. In one variation, a holdout sample of the data is also used with the two step model and the determined outcome predictor to verify the predictor produced.

### DISCLOSURE OF THE INVENTION

The present invention quantifies mutational phenotypes between different organisms, suggesting non-obvious models for human disease, including a yeast model of angiogenesis and a plant model of craniofacial alterations. The inventors define orthologous phenotypes between organisms (phenologs) based upon overlapping sets of orthologous genes associated with each phenotype. Comparisons of 212,542 human, mouse, yeast, worm, and plant gene-phenotype associations reveal many significant phenologs, including novel non-obvious human disease models. Phenologs suggest a yeast model for angiogenesis defects, a worm model of breast cancer, and a plant model for the neural crest defects associated with Waardenburg syndrome, among others.

In one embodiment the present invention describes a method of identifying one or more candidate genes for a trait, a phenotype, or a disease of interest by identifying one or more orthologous genes involving the trait, the phenotype, or the disease of interest. This identification involves comparing a first set of genes associated with a first phenotype in a first organism with a second set of genes associated with a second phenotype in a second organism, and the first and second phenotypes do not have one or more common characteristics, and the second phenotype in the second organism is selected such that at least one gene belongs to both the first and the second set of genes in the first and the second organisms, respectively. After the identification step one or more candidate genes from the second set of genes associated with the second phenotype are selected from the second organism other than the genes known to overlap between the first and the second phenotypes as the candidate genes for belonging to the first phenotype in the first organism.

The method of the present invention further comprises the step of modifying the expression of one or more candidate genes in the first organism to confirm its equivalency to the one or more candidate genes of the second phenotype of the second organism. In one aspect the first organism is selected from group comprising a human, a mouse, a worm, an amphibian, a fish, a fungus, an animal, and a plant and the second organism is selected from a group comprising a human, a mouse, a worm, an amphibian, a fish, a fungus, an animal, and a plant. In another aspect the two comparison gene sets compares a mammalian gene set with a yeast cell gene set, a worm cell gene set, a fish gene set, an amphibian gene set, a plant gene set, or a different mammalian gene set. In yet another aspect the two comparison gene sets compares a yeast gene set with a mammalian gene set, a worm cell set, a fish set, an amphibian set, a plant set, or a different yeast gene set.

In the method of the present invention the one or more candidate genes comprises genes previously unknown to have an association with a human phenotype. In one aspect the first dataset comprises a human disease gene set, and the second dataset comprises a gene set selected from a group comprising a yeast, a fungus, a worm, a mouse, an animal, another mammal, an amphibian, a plant, and a fish. In another aspect the step of selecting the one or more candidate genes is defined further as comprising measuring the p (overlap>k|n,m,N) for each disease-phenotype pair. In yet another aspect the step of identifying the second phenotype and the second set of genes or both is defined further as comprising the selection of all significant candidate genes by permutations or reciprocal best hits and further comprises the step of calculating a confidence value for each potential candidate gene based on the hypergeometric probability of observing at least that many shared orthologous genes by random chance. In specific aspects the method of the present invention further comprises the steps of identifying a new disease model system based on the one or more candidate genes and the step of testing the first organism for a disease phenotype.

In another embodiment the present invention is a method of identifying one or more candidate genes for a trait, a phenotype, or a disease of interest comprising the steps of identifying one or more orthologous genes involving the trait, the phenotype, or the disease of interest, by: (i) comparing a first set of genes associated with a first phenotype in a first organism with a second set of genes associated with a second phenotype in a second organism, wherein the first and the second organisms are different, wherein the first and second phenotypes do not have one or more common characteristics, (ii) calculating and selecting using a database of gene-phenotype associations such that at least one gene belongs to both the first and the second set of genes in the first and the second organisms respectively, and (iii) selecting from the second organism one or more candidate genes from the second set of genes associated with the second phenotype other than the genes known to overlap between the first and the second phenotypes as the candidate genes for belonging to the first phenotype in the first organism. The method further comprises the step of modifying the expression of one or more candidate genes in the second organism to confirm its equivalency to the one or more candidate genes of the first phenotype in the first organism.

In one aspect the first and the second organisms are selected from a group comprising a human, a mouse, a worm, an amphibian, a fish, a fungus, an animal, and a plant. In one aspect, the first set of genes is selected from the group consisting of a mammalian gene set, a yeast cell gene set, a worm gene set, a fish gene set, an amphibian gene set, and a plant gene set; and the second set of genes is selected from the group consisting of a different mammalian gene set, a yeast cell gene set, a worm gene set, a fish gene set, an amphibian gene set, and a plant gene set. In another aspect the first set of genes is a human gene set and the second set of genes is selected from the group consisting of a non-human mammalian gene set, a yeast gene set, a worm gene set, a fish gene set, an amphibian gene set, and a plant gene set. In another aspect the first set of genes is a yeast gene set and the second set of genes is selected from the group consisting of a mammalian gene set, a different yeast gene set, a worm gene set, a fish gene set, an amphibian gene set, and a plant gene set. In yet another aspect the first set of genes is a plant gene set and the second set of genes is selected from the group consisting of a mammalian gene set, a yeast gene set, a worm gene set, a fish gene set, an amphibian gene set, and a different plant gene set.

In another aspect the one or more candidate genes comprises genes previously unknown to have an association with a human phenotype. In one aspect the first dataset comprises a human disease gene set, and the second dataset comprises a gene set selected from a group comprising a yeast, a fungus, a worm, a mouse, an animal, another mammal, an amphibian, a plant, and a fish. In a specific aspect the step of selecting the one or more candidate genes is defined further as comprising measuring the p (overlap>k|n, m, N) for each disease-phenotype pair. In another aspect the step of identifying the second phenotype genes is defined further as comprising the selection of all significant candidate genes by permutations or reciprocal best hits. In yet another aspect the step of identifying the second phenotype genes is defined further as comprising the step of calculating a confidence value for each candidate gene based on the hypergeometric probability of observing at least that many shared orthologous phenotypes by random chance.

The method of the present invention further comprises the steps of (i) identifying a new disease model system based on the one or more candidate genes and (ii) testing the second organism for the disease phenotype.

Yet another embodiment of the present invention describes a method of identifying a novel disease model system comprising the steps of comparing a first mutant genotype database of a first organism with a first phenotype with a second mutant genotype database of a second organism with a second phenotype, wherein the first and the second organisms are different, wherein the first and second mutant genotypes have one or more common characteristics, selecting in the first organism one or more first phenotype genes, other than the first mutant genotype from the first mutant genotype database, that overlap with one or more second phenotype genes, other than the second mutant genotype from the second mutant genotype database, identifying if the second organism has one or more second phenotype genes that are equivalent to the first phenotype genes from the first organism from the second mutant genotype database, and testing the second organism for the disease phenotype. In a related aspect the second organism is a non-human organism comprises a yeast, a mouse, an amphibian, a plant, a fish or another mammal.

The present invention further provides a method of identifying one or more candidate genes for a phenotype or disease of interest in a first species by using a combination of phenotypes from one or more comparison species, wherein the first species and the one or more comparison species are different. The identification method comprises the steps of: (i) identifying and storing in an orthologous gene dataset of one or more orthologous genes of the first species in the one or more comparison species by: (a) creating a gene-phenotype association prediction matrix for the first species comprising one or more columns, rows, and cells, wherein the columns comprise one or more first species phenotypes or diseases and the rows comprise one or more first species genes, wherein any genes not having any identifiable orthologous genes in the comparison species are excluded, and wherein the value of cells correspond to associations between the first species genes with first species phenotypes or diseases and (b) creating a gene-phenotype association source matrix for each of the one or more comparison species comprising one or more columns, rows, and cells, wherein the columns comprise one or more comparison species phenotypes or diseases and the rows comprise one or more first species genes which have orthologous genes in the one more comparison species, and wherein values of cells correspond to associations between comparison species phenotypes or diseases with comparison species orthologous genes of first species genes, (ii) determining one or more phenologs by a calculation of an inter-column distance between each of the phenotypes in the source matrix and a phenotype or disease in the prediction matrix, wherein the determination is based on a hypergeometric probability calculation or a similar technique and storing the phenologs in a phenolog dataset, and (iii) identifying one or more phenotype-gene associations in the first species based on associations in a selection or combination of one or more phenotypes in the source matrix with a smallest inter-column distance with the column corresponding to the phenotype in the prediction matrix. In one aspect the first species is a human species. In another aspect the one or more comparison species are non-human species selected from the group consisting of a yeast, a mouse, an amphibian, a plant, a fish, a worm or another mammal. In yet another aspect the method further comprises the step of evaluating the accuracy of the prediction results by one or more cross-validating techniques.

Another embodiment of the instant invention describes a method of identifying one or more disease genes in a human species by using a combination of phenotypes from one or more comparison non-human species comprising the steps of: identifying and storing in an orthologous gene dataset of one or more orthologous genes of the human species in the one or more additional species by: (a) creating a gene-disease association prediction matrix for the human species comprising one or more columns, rows, and cells, wherein the columns comprise one or more human species diseases and the rows comprise one or more human species genes, wherein any genes not having any identifiable orthologous genes in the comparison species are excluded, and wherein the value of cells correspond to associations between human species genes with human species diseases and (b) creating a gene-phenotype association source matrix for each of the one or more comparison species comprising one or more columns, rows, and cells, wherein the columns comprise one or more comparison species phenotypes or diseases and the rows comprise one or more human species genes which have orthologous genes in the one or more comparison species, and wherein values of cells correspond to associations between comparison species phenotypes or diseases with comparison species orthologous genes of human species genes; determining one or more phenologs by a calculation of an inter-column distance between each of the phenotypes in the source matrix and a disease in the prediction matrix, wherein the determination is based on a hypergeometric probability calculation or a similar technique and storing the phenologs in a phenolog dataset; and identifying one or more human species disease-gene associations based on associations in a selection or combination of one or more phenotypes in the source matrix with a smallest inter-column distance with the column corresponding to the disease in the prediction matrix. In one aspect of the method the one or more non-human species are selected from the group consisting of a yeast, a mouse, an amphibian, a plant, a fish, a worm or another mammal. In another aspect the method further comprises the step of evaluating the accuracy of the prediction results by one or more cross-validating techniques.

### DESCRIPTION OF THE DRAWINGS

For a more complete understanding of the features and advantages of the present invention, reference is now made to the detailed description of the invention along with the accompanying figures and in which:

FIG. 1A is a graph indicating that the rate of associating genes to phenotypes in model organisms greatly exceeds that in humans. The data is obtained from Hodgkin et al., 1979, Richardson et al., 2006, Scanlan et al., 2001, Amberger et al., 2008 and Dwight et al., 2002;

FIG. 1B shows that orthologous phenotypes can be identified based on significantly overlapping sets of orthologous genes (A is orthologous to A′, B to B′, etc), such that each gene in a given set (green box or cyan box) gives rise to the same phenotype in that organism;

FIG. 1C is an example of a phenolog mapping revealing that a high incidence of male C. elegans progeny maps to human breast/ovarian cancers;

FIG. 1D is an example of a phenolog mapping, revealing that human/yeast gene orthologs associated with human porphyria (a defect of heme biosynthesis) significantly overlap genes associated in yeast with sensitivity to the tyrosine kinase inhibitor damnacanthal;

FIG. 2A is an example of a flowchart for systematic identification of phenologs. For a pair of organisms, sets of genes known to be associated with mutational phenotypes are assembled, considering only orthologous genes between the two organisms. Pairs of mutational phenotypes—one phenotype from each organism, each associated with a set of genes—are then compared to determine the extent of overlap of the associated gene sets;

FIG. 2B shows the enrichment for phenologs above random expectation can be seen following all pairwise comparisons of the mutational phenotypes from mouse, human, yeast, or worm. The significance of overlap is calculated by hypergeometric probability. Comparison of the distribution of observed probabilities with those derived from the same analysis following permutation of gene-phenotype associations reveals that many more orthologous phenotypes are observed than expected by random chance;

FIG. 2C is a quantitative examination of each inter-organism phenotype pair, measuring the significance of each. In order to correct for testing multiple hypotheses, all the analyses were repeated 1,000 times with randomly permuted gene-phenotype associations. A false discovery rate (FDR) based upon the observed null distribution of scores was calculated for each organism pair;

FIG. 3 is a flowchart for applying the phenolog framework to identify a candidate human neural tube birth defect (NTD) genes, e.g. from worm phenotype data;

FIG. 4A is an example of a non-obvious disease model revealed by phenologs: yeast mutants sensitive to the hypercholesterolemia drug lovastatin predict mammalian angiogenesis defects. The set of 8 genes (considering only mouse/yeast orthologs) associated with mouse angiogenesis defects and the set of 67 genes associated with lovastatin hypersensitivity in yeast significantly overlap, suggesting that the yeast gene set may predict angiogenesis genes. This prediction was verified in Xenopus embryos for the case of the transcription factor xSOX12;

FIG. 4B illustrates xSOX12 expression in a developing Xenopus vasculature, as measured by in situ hybridization;

FIG. 4C shows xSOX12 expression in veins and developing heart of a stage 32 Xenopus embryo, as measured by in situ hybridization.

FIG. 4D is an illustration of defects in a developing Xenopus vasculature induced by Morpholino (MO) knockdown of xSOX12 and measured using in situ hybridization versus two independent markers of the vasculature, the angiogenesis-regulating transcription factor Erg and the angiotensin receptor homolog XMsr;

FIG. 4E is an illustration of apparent hemorrhaging in stage 45 Xenopus embryos due to dysfunctional vasculature following xSOX12 morpholino knockdown (12 of 50 animals tested; 2 also showed unusually small hearts with defective morphology; right-hand panel magnifies yellow boxed region in middle panel), but is rare in control animals (1 of 45 tested untreated animals, 1 of 22 xSOX12-mismatch morpholino (MM) control knockdown animals tested);

FIG. 4F shows an in vitro human umbilical vein endothelial cell model of angiogenesis. Knockdown of human SOX13 by siRNA disrupts tube formation (an in vitro model for capillary formation) to an extent comparable to knockdown of a known effector of angiogenesis (HOXA9) and significantly more than untreated cells or cells transfected with an off-target (scrambled) negative control siRNA. Scale bar, 100 μM;

FIG. 5A is a schematic representation validating two new neural tube defect genes predicted by phenology and gene networks;

FIG. 5B Morpholino knockdowns of Xenopus genes RFX2 and IFT140 show strong neural tube defects (top right) in comparison to the control animals. Immunofluorescence of the Xenopus ciliated epithelium from IFT140 or RFX2 morpholino knockdown animals reveals normal deployment of basal bodies (centrin marker) but abnormal or missing cilia (−tubulin marker) on multiciliated epithelial cells;

FIG. 5C illustrates representative in situ hybridization versus TEX15, a marker of ciliated cell fate specification, in RFX2-MO knockdown animals shows that ciliated cells are intact, but lack cilia. The numbers of ciliated cells visible per embryo did not differ significantly between control and RFX2-MO embryos (13 control embryos were scored, with 6 showing high numbers of ciliated cells, 4 medium, 3 low; 11 RFX-MO embryos were scored showing 4 high, 6 medium, 1 low; no significant difference by chi-square test.);

FIG. 6 shows enhanced interconnectivity in gene networks for genes involved in phenologs, for worm (top) and yeast (bottom) gene networks;

FIG. 7A shows that phenologs reveal plant models of human disease, including a model of Waardenburg syndrome (WS) neural crest defects. Many orthologous phenotypes are observed between Arabidopsis and worms, yeast, mouse, and humans, with hundreds more than expected by chance. Many mammalian/plant phenologs relate to vertebrate developmental defects, including models for WS and other birth defects;

FIG. 7B shows the enrichment for phenologs above random expectation seen following all pairwise comparisons of Arabidopsis phenotypes with those from mouse, human, yeast, or worm;

FIG. 7C is an illustration considering only human/Arabidopsis orthologs, the 3 known WS genes significantly overlap the 5 genes associated with negative gravitropism defects in Arabidopsis, the plant gene set suggests new candidate WS genes; the inset at the side shows a magnified region of the in situ hybridization results in FIG. 7D;

FIG. 7D represents in situ hybridization versus candidate SEC23IP in developing Xenopus embryos confirming neural crest cell expression;

FIG. 7E shows the unilateral morpholino knockdown of SEC23IP inducing defects in neural crest cell migration on the side with the knockdown but not the control side, measured using in situ hybridization versus two independent markers of neural crest cells;

FIG. 7F shows the neural crest defects induced by morpholino (MO) knockdown of SEC23IP and measured by in situ hybridization versus the neural crest marker gene slug (defects observed in 23 of 35 animals tested). Such defects are rare in untreated control animals and off-target morpholino (OM) knockdowns (0 of 21 control animals tested with slug; 1 of 140M animals tested with slug);

FIG. 7G shows that morpholino (MO) knockdown of SEC23IP induces defects in neural crest cell migration, measured using in situ hybridization versus Twist, an independent marker of the neural crest cells (8 of 14 animals tested). Such defects are rare in untreated control animals (0 of 14 control animals tested with Twist);

FIG. 8 is a possible extension to the phenolog framework include considering gene homology, rather than orthology, in calculating the phenologs, as well as identifying paralogous phenotypes in the same organism as a different means of identifying candidate genes for a phenotype of interest; and

FIG. 9 shows ten-fold cross-validated test results of strong disease gene prediction by single phenologs for ˜⅙ to ⅕ of tested diseases; simple weighted combinations of phenologs (e.g., evaluating the k=40 best phenologs) provide strong predictability for approx. ⅓ to ½ of the tested diseases.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention demonstrates a computational method, reduced to practice, for suggesting non-obvious human disease models and associated disease-relevant genes. In addition the present invention quantifies the equivalence of mutational phenotypes between different organisms thereby, suggesting non-obvious models for human disease. The models described by the present invention also suggest new disease-relevant genes. For example, although worms entirely lack neural tubes, they may nonetheless serve as useful models for aspects of neural tube development, suggesting new genes relevant to neural tube defect diseases such as spina bifida, provided the appropriate pathways are identified. Similarly, although yeast entirely lack arteries and veins, certain gene processes in yeast are relevant to mammalian angiogenesis, and yeast mutants in these processes can be applied to discover new angiogenesis-relevant genes.

To facilitate understanding of the invention, a number of terms are defined below.

As used herein the term “gene” refers to an element defining a genetic trait. A gene is typically arranged in a given sequence on a chromosome. The term “gene” is also used to refer to a functional protein, polypeptide or peptide-encoding unit. As will be understood by those in the art, this functional term includes both genomic sequences, cDNA sequences, or fragments or combinations thereof, as well as gene products, including those that may have been altered by the hand of man.

The terms “ortholog” and “orthologous” refer to a nucleic acid or peptide sequence or gene which functions similarly to a nucleic acid or peptide sequence or gene from another species. For example, where one gene from one plant species has a high nucleic acid sequence similarity and codes for a protein with a similar function to another gene from another plant species, such genes would be “orthologs”. Orthologs are also defined as genes that have diverged after a speciation event, thus implying that products of orthologous genes should tend to keep their original functions. “Paralogs” on the other hand, are defined as genes that have diverged after a duplication event.

As used herein the term “trait” encompasses any characteristic, especially one that distinguishes one animal from another. The term “phenotype” may be used interchangeably with the term “trait” and refers to a species characteristic that is readily observable or measurable and results from the interaction of the genetic make-up of the species with the environment in which it develops. Such a phenotype includes chemical changes in the make-up resulting from enhanced gene expression which may or may not result in morphological changes in the species, but which are measurable using analytical techniques known to those of skill in the art. As used herein, the term “genotype” means the genetic makeup of an individual cell, cell culture, plant, or group of plants.

The term “organism” as used in this specification refers to any contiguous living system (animal, plant, fungus or micro-organism). In at least some form, all organisms are capable of response to stimuli, reproduction, growth and development, and maintenance of homoeostasis as a stable whole. An organism may either be unicellular (single-celled) or be composed of, as in humans, many trillions of cells grouped into specialized tissues and organs. The term multicellular (many-celled) describes any organism made up of more than one cell.

The term “wild-type” refers to a gene or gene product which has the characteristics of that gene or gene product when isolated from a naturally occurring source. A wild-type gene is that which is most frequently observed in a population and is thus arbitrarily designated the “normal” or “wild-type” form of the gene. In contrast, the term “modified” or “mutant” refers to a gene or gene product which displays modifications in sequence and or functional properties (i.e., altered characteristics) when compared to the “wild-type” gene or gene product. It is noted that naturally-occurring “mutants” can be isolated; these are identified by the fact that they have altered characteristics when compared to the “wild-type” gene or gene product.

The term “hypergeometric probability” is a discrete probability distribution that describes the number of successes in a sequence of n draws from a finite population without replacement, just as the binomial distribution describes the number of successes for draws with replacement.

The term “reciprocal best hit (RBH)” refers to common working definition or method of orthology, whereby two genes residing in two different genomes are deemed orthologs if their protein products find each other as the best hit in the opposite genome.

A “disease model” refers to a cellular system that produces observable characteristics correlated with the pathological process of a disease, where at least some characteristics of the system reflect the status of the disease model. Such a model can, for example, include an in vivo system in which a particular disease is developing, or a system that has sufficient similarity to a disease system so that changes in the model system are reasonably correlated with and predictive of effects in a corresponding disease system.

A “dataset” refers to any gene or groups of genes, data points or associations created and transformed or are modified using the present invention. These datasets may include, e.g., the name, sequence or other identifying information sufficient to identify the gene, disease, disease model or condition that links a nucleic acid or peptide sequence or gene which functions similarly to a nucleic acid or peptide sequence or gene from another species.

The present invention differs from present approaches in its basic concept and quantitative framework. The present invention is a first of a kind quantitative approach for generic identification of the best disease models. In addition the present invention introduces the novel concept of phenotype orthology. For example, the approach of the present invention rapidly identifies the best worm model for neural tube defect diseases such as spina bifida, and then applies the worm model to suggest and experimentally validate two new vertebrate genes that were confirmed to cause spinal cord closure defects upon gene knockdown. This aspect is particularly notable as worms have no spinal cords.

The present invention identifies orthologous phenotypes between organisms (phenologs) based upon overlapping sets of orthologous genes associated with each phenotype. The phenologs suggest new disease models and candidate disease genes by identifying adaptive reuse of gene systems. The method of the present invention addresses the difficult problem of mapping the genotype and phenotype, which is often non-obvious, and predicting genes underlying a particular phenotype. The present invention compares over 212,000 human, mouse, yeast, worm, and plant gene-phenotype associations to reveal many significant phenologs, recapitulating known disease models. Non-obvious human disease models are revealed by the present invention, including a yeast model for aspects of mammalian angiogenesis based on lovastatin sensitivity and a worm model for breast/ovarian cancer based on mutations increasing male progeny. The present invention further exploits phenology to demonstrate neural tube defects associated with vertebrate genes IFT140 and RFX2, identified on the basis of their worm mutational phenotypes. A gene or genes, or lists of genes, that form part of the identified sets can be stored in a dataset for further processing and analysis.

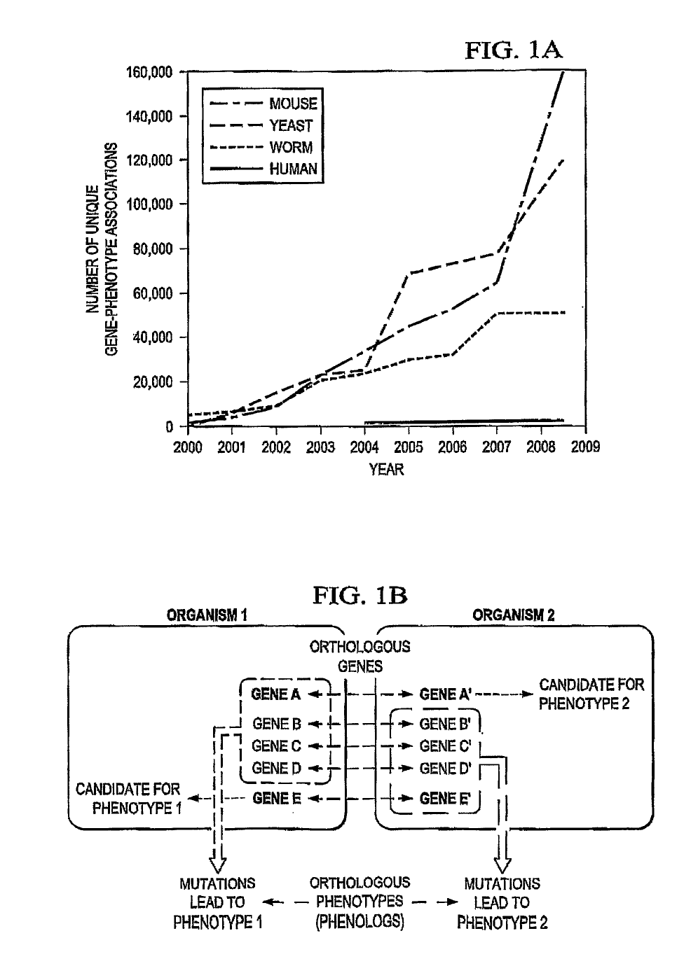

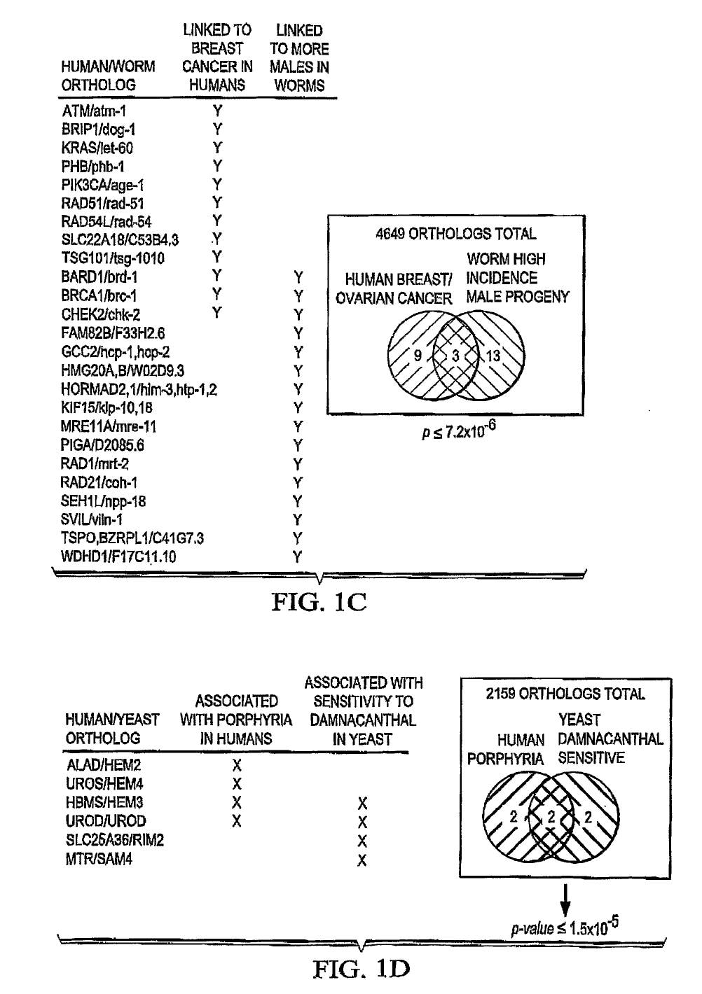

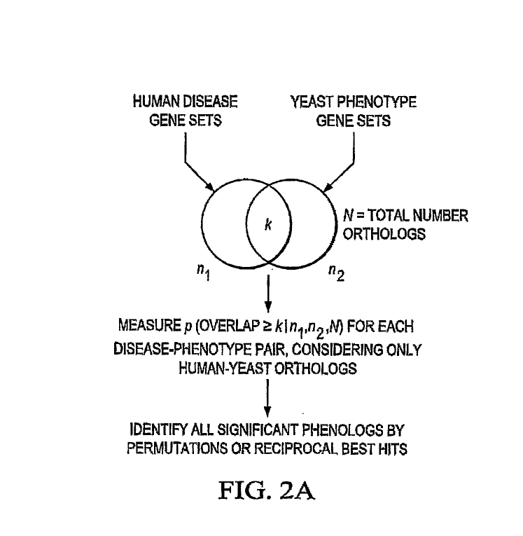

Genetics researchers have long noticed that disrupting a gene's function in one organism can often lead to a radically different outcome in another organism—e.g., mutating the RB1 gene in humans gives rise to retinoblastoma [1], a cancer of the retina, yet disrupting the RB1 ortholog (and a second redundant gene) in the nematode C. elegans gives rise to ectopic vulvae [2]. Mutant phenotypes are thus an emergent property of the system; disruptions of equivalent genes with conserved molecular functions, but in different systems contexts, can lead to different outcomes. Additionally, diverse genetic perturbations can give rise to the same phenotypic outcome; e.g., there are many lethal mutations, causing lethality by different molecular mechanisms. Mutation of a single gene can also lead to multiple phenotypic outcomes, a notion known as pleiotropy. Genes and phenotypes thus have a many-to-many relationship, and mapping equivalent phenotypes between organisms is non-obvious. This mapping is particularly important for models of human disease. As shown in FIG. 1A, thousands of genome-wide mutational analyses have now been performed for many model organisms, e.g., yeast, worms, flies, and mice, associating genes to phenotypes at a far higher rate than for humans.

The present invention suggests that considering equivalent phenotypes between organisms will lead to the discovery of new models of human disease.

The present invention introduces the novel concept introduce of orthologous phenotypes (dubbed phenologs) as a framework for considering equivalent phenotypes. Phenologs are defined as phenotypes related by the orthology of the associated genes in two organisms. As shown in FIG. 1B, phenologs can be identified from sets of genes in two organisms such that the genes within one organism are associated with the same phenotype—the phenotypes can be different between the organisms—with the sets significantly enriched for orthologous genes between the organisms. The phenotypes may differ in appearance between organisms due to differing organismal contexts. As gene-phenotype associations are often incompletely mapped, genes currently linked to only one of the orthologous phenotypes become candidate genes for the other phenotype, e.g., the gene A′ is a new candidate for phenotype 2.

Phenologs are thus the phenotype-level equivalent of gene orthologs; they are evolutionarily conserved outputs of systems of genes, which can manifest differently in different organisms (e.g., as different traits or structures) due to interactions with the remaining genes. The human retinoblastoma eye cancer and the C. elegans synthetic multivulval phenotype are phenologous, with failures of orthologous genes performing equal molecular functions in different contexts causing different phenotypic outcomes. Phenologs thus bridge the molecular definitions of homologous and orthologous genes [3] with classic definitions of homologous structures from Darwin [4] and Owen [5], deriving from considerations both of gene heredity and the traits/structures affected by perturbing the genes.

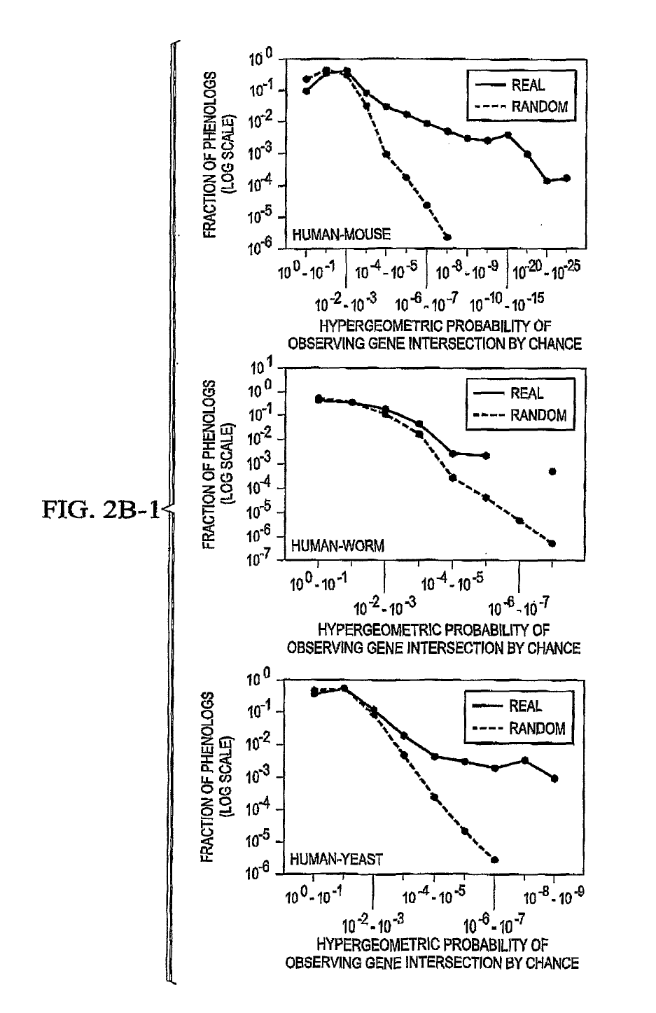

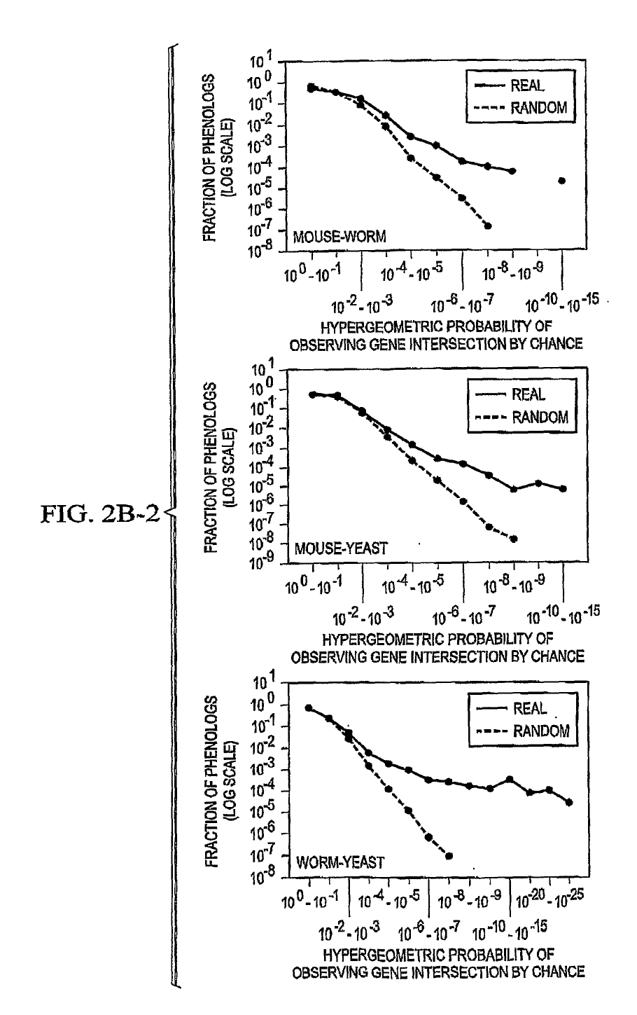

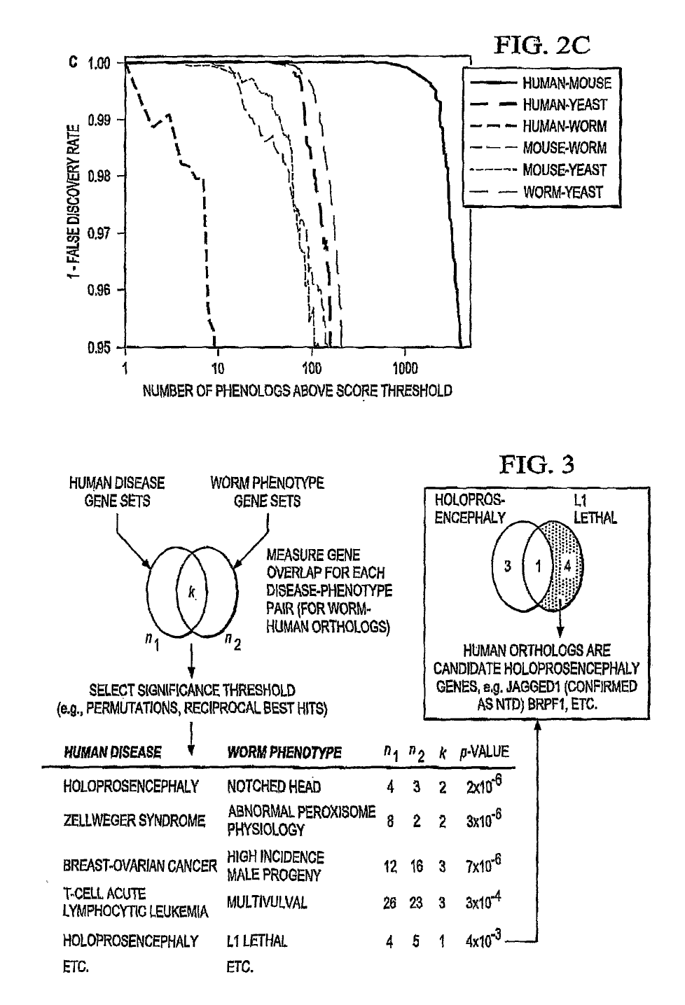

In a study to test the idea of phenologs, gene-phenotype associations for humans and three well studied model organisms (yeast, worm, and mouse) from literature and databases was assembled. Gene-phenotype associations are available from the Online Mendelian Inheritance in Man (OMIM) database [6] and from model organism genome databases, including the Saccharomyces Genome Database [7], WormBase [8], and the Mouse Genome Database [9]. Genes linked to more than ˜300 human diseases and >3,000 model organism phenotypes are available in the database, spanning >2,300 human disease-gene associations [6], >158,000 mouse gene-phenotype associations [9], >50,000 C. elegans gene-phenotype associations [8], and >118,000 yeast gene-phenotype associations [7, 10-12]. The phenotypes with no genes yet mapped were filtered out and bi-allelic phenotypes were removed. A set of 1,924 human disease-gene associations [6]. 73,755 transgenic mouse phenotype-gene associations [9], 28,131 C. elegans gene-phenotype associations [8], and 113,558 yeast gene-phenotype associations [7, 10-12], spanning ˜300 human diseases and >3,000 model organism phenotypes was collected from the literature. Armed with the data and the sets of orthologous gene relationships between each pair of organisms [13], each inter-organism phenotype pair was quantitatively examined, by measuring the number of total genes in organism 1 (with orthologs in organism 2) giving rise to phenotype 1, those in organism 2 giving rise to phenotype 2, and the total number of orthologs shared between the two sets. The confidence in each potential phenology was calculated as the hypergeometric probability of observing at least that many shared orthologs by random chance. The results of the study described above are presented in FIG. 2B.

To correct for testing multiple hypotheses, the analyses was repeated 1,000 times with randomly permuted gene-phenotype associations, calculating a false discovery rate based upon the observed null distribution of scores (FIG. 2C). This resulted in the observation of thousands of significant phenologs between human diseases and model organism mutational phenotypes as illustrated in FIG. 3.

FIG. 1C shows an example of the aspect discussed above, the set of human genes (with worm orthologs) associated with X-linked breast/ovarian cancer significantly overlaps genes whose mutations lead to a high frequency of male progeny in C. elegans. Male C. elegans are determined by a single X chromosome, hermaphrodites by 2 copies; thus, X chromosome non-disjunction leads to higher frequencies of males [14]. Human breast/ovarian cancers can derive from a similar mechanism, e.g. as for sporadic basal-like breast cancers [15], supporting the notion that this phenolog is identifying a useful disease model. Human orthologs of the 13 additional genes associated with the worm trait are thus reasonable candidate genes for involvement in breast/ovarian cancers. Nine of these genes were not yet linked to breast cancer in the databases we employed, but could be confirmed as such in the primary literature (e.g., as for the breast cancer biomarker KIF15 [16]); 4 genes (GCC2, PIGA, WDHD1, SEH1L) remain as breast cancer candidate genes. The worm phenotype thus predicts and suggests additional genes relevant to human breast cancer.

FIG. 1D shows an another example, revealing that human/yeast gene orthologs associated with human porphyria (a defect of heme biosynthesis debated as the basis for vampire legends [17] and the madness of King George III [18]) significantly overlap genes associated in yeast with sensitivity to the tyrosine kinase inhibitor damnacanthal [10]. Thus, the yeast pathway perturbed by damnacanthal is predictive of and could in principle suggest additional genes related to human porphyria.

FIG. 2A illustrated a framework for systematic identification of phenologs. For a pair of organisms, sets of genes known to be associated with mutational phenotypes are assembled, considering only orthologous genes between the two organisms. Pairs of mutational phenotypes—one phenotype from each organism, each associated with a set of genes—are then compared to determine the extent of overlap of the associated gene sets, calculating the significance of overlap by the hypergeometric probability.

Reasonable equivalences are identified in this manner nonviable C. elegans following RNAi were found to be phenologous to inviable yeast following gene deletion, based upon the observation that 422 worm genes (with yeast orthologs) are associated with nonviability, 642 yeast genes (with worm orthologs) are associated with nonviability, with 234 orthologs shared between these sets (p≦10⁻¹⁰). Embryonic lethality before somite formation in mice is found to be phenologous to nonviable C. elegans following RNAi (p≦10⁻¹⁰). Mouse pre- or peri-natal lethality, as well as embryogenesis defects, are phenologous with sterile C. elegans following RNAi (p)≦10⁻¹⁰). Similar equivalences are found between mouse and yeast, and the other organisms, for many related lethality, sterility, and embryonic developmental phenotypes. Thus, the framework of the present invention correctly recaptures intuitively obvious phenologs.

In addition the present invention more importantly, reveals many more specific phenologs, especially for the comparison of mouse and human phenotypes; these nicely recapitulate many known mouse models of disease. Table I lists specific examples. For example, one of the most significant phenologies identified between human disease and mouse mutational phenotypes is that linking Bardet-Biedl syndrome with four mouse traits, each of which relates to the disruption of ciliary function (abnormal brain ventricle/choroid plexus morphology, small hippocampus, enlarged third ventricle, absent sperm flagella; all p≦10⁻¹¹), consistent with the apparent molecular defects in Bardet-Biedl syndrome. The argument is thus that mouse ciliary defects provide a powerful model for studying human Bardet-Biedl syndrome, at least at the level of identifying and characterizing genes associated with this syndrome, consistent with its recent utility in this regard [19]. Similarly, human zonular pulverulent cataracts are observed to be phenologous to mouse cataracts (p≦10⁻²⁴), human obesity with impaired prohormone processing is phenologous to mouse obesity (p≦10⁻¹³), human X chromosome-linked deafness to mouse deafness (p≦10⁻¹³), human retinitis punctata albescens to mouse retinal degeneration (p≦10⁻¹³), and human nonendemic goiter to mouse enlarged thyroid glands (p≦10⁻⁸). Thus, the calculation of phenologs correctly identifies many known mouse models of human diseases, and therefore has the potential to identify new models.

Table I: Examples from the >6,200 significant phenologs detected among human (Hs) diseases and mouse (Mm), yeast (Sc), worm (Ce), and Arabidopsis (At) mutant phenotypes. n₁ indicates the number of orthologs in organism 1 with phenotype1, n₂ the number in organism 2 with phenotype 2, and k the number in both sets. The significance of each phenolog is assessed by the hypergeometric probability (p-value), the positive predictive value (PPV) when considering multiple testing (1-FDR), and the reciprocal best hit criterion (bold text). 22,921 Arabidopsis gene-phenotype associations were collected spanning 1,711 unique phenotypes—assembled from primary literature and from the Arabidopsis Information Resource (TAIR) web database (http://www.arabidopsis.org)—in order to discover phenologs involving plant phenotypes, analyzing these data as for the other organisms.

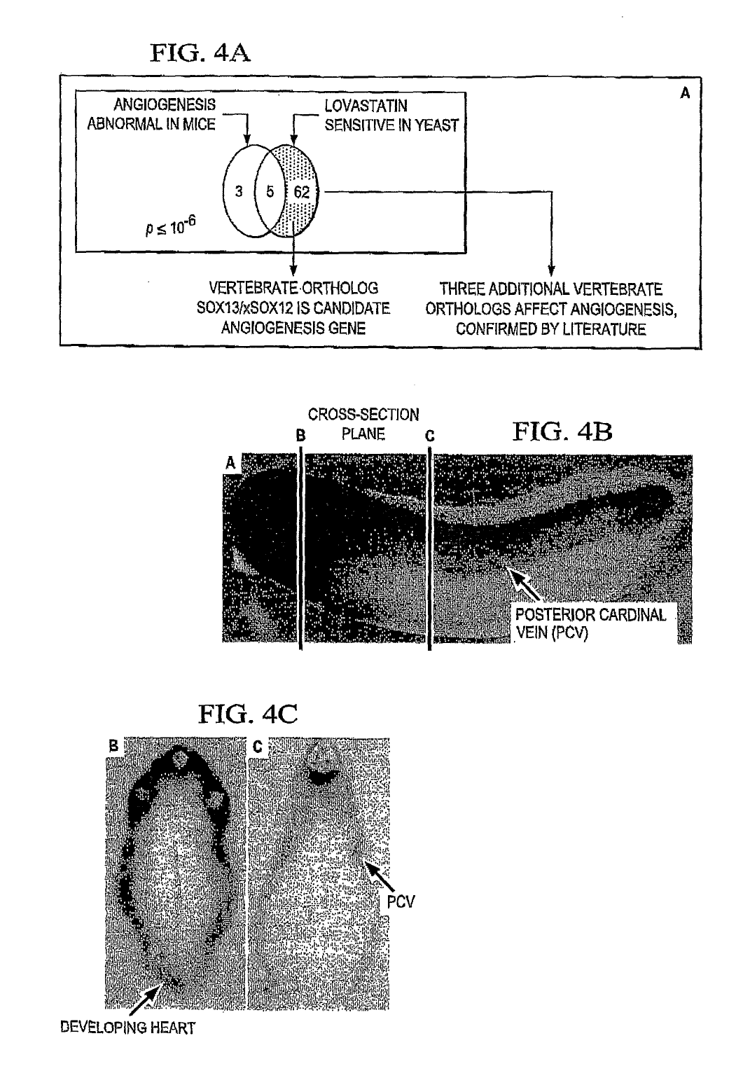

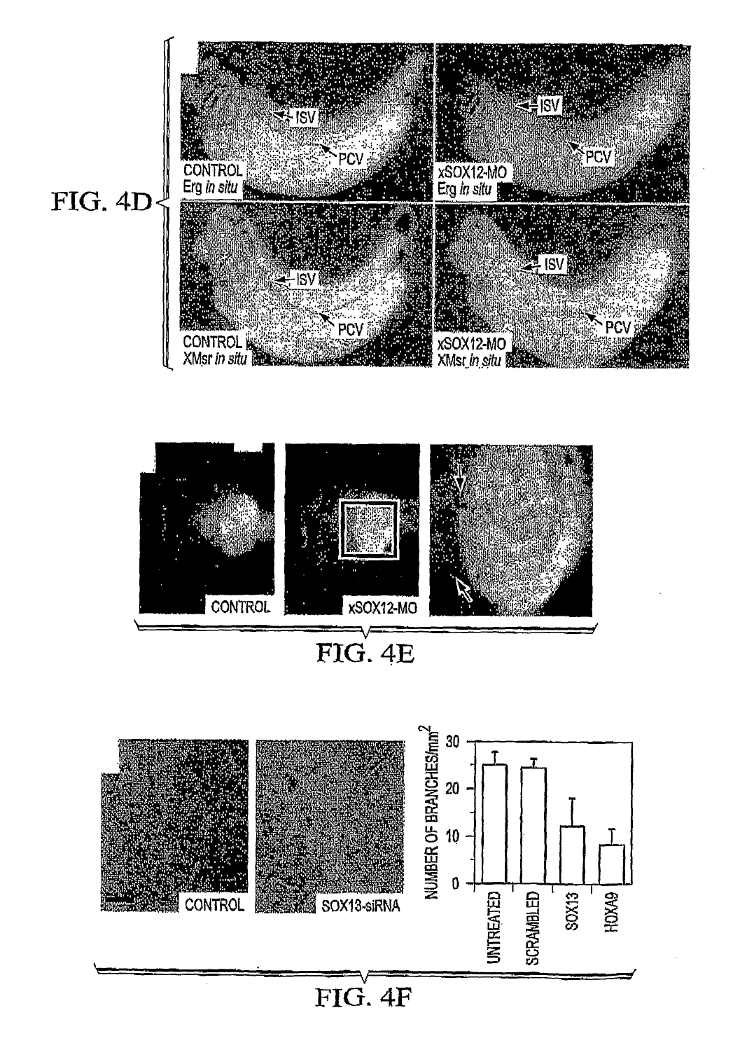

The power of the phenolog framework of the present lies in discovery of non-obvious disease models. The study revealed a serendipitous phenolog between abnormal angiogenesis in mutant mice and reduced growth rate of yeast deletion strains when grown in the hypercholesterolemia drug lovastatin (8 mouse genes, 67 yeast, 5 shared, p≦10⁻⁶) as seen in FIG. 4A. This observation, consistent with the action of lovastatin in reducing tumor-induced angiogenesis (e.g., [20]), suggests that budding yeast, which entirely lack blood vessels, could potentially model certain aspects of mammalian vasculature formation, at least at the level of defining genes affecting this process. In particular, the five shared genes between these processes are, in yeast, the MAP kinases SLT2, PBS2, and HOG1, the calcineurin B protein CNB1, and the uncharacterized protein VPS70; the four characterized proteins regulate osmosensing and aspects of cell wall organization and biogenesis. Strikingly, mutations of their mouse orthologs (MAPK7, MAP2K1, MAPK14, PPP3R1, and the prostate-specific membrane antigen PSMA) all show strong angiogenesis defects—e.g., MAPK7 deletion causes defective blood vessel and cardiac development [21]; ablation in adult mice leads to leaky blood vessels [22]. Similarly, PSMA regulates angiogenesis by modulating integrin signal transduction [23]. Thus, it appears that this conserved subnetwork of genes was alternately repurposed to regulate osmosensing and cell wall biogenesis in yeast cells and proper formation and maintenance of blood vessels in mice.

The orthology of phenotypes of the present invention predicts that additional human orthologs of genes associated with the model organism trait are more likely to be associated with the human disease. This was examined in a study of yeast angiogenesis model for other yeast genes whose deletion induced sensitivity to lovastatin and which possessed a mammalian ortholog. Of the 62 candidates, three of the corresponding mouse genes were confirmed by literature to be involved in angiogenesis, but had yet to be annotated as such in the Mouse Genome Database. These genes included the known target of lovastatin, HMG-CoA reductase, whose role in angiogenesis has been previously observed [24], the sirtuin SIRT1, whose disruption in zebrafish and mice resulted in defective blood vessel formation and blunted ischemia-induced neovascularization [25], and the casein kinase Csnk2a1, inhibitors of which inhibit retinal neovascularization in a mouse model [26]. Additional genes were involved in other aspects of cardiovascular development, such as the gene mitoferrin, being expressed most highly in hematopoietic organs, fetal liver, bone marrow, and spleen, and mutations in which block terminal erythroid maturation, leading to profound anemia [27]. Similarly, SMAP1 positively regulates erythrocyte differentiation, and high expression of SOX13 is restricted to arteries during late embryogenesis [28], regulating T lymphocyte differentiation [29].

Thus, mammalian orthologs of the 62 additional genes causing lovastatin-sensitivity in yeast are significantly enriched for genes relevant to cardiovascular development, serving to validate the approach of the present invention.

To directly validate the predictions of this phenolog, the inventors examined the 59 candidate genes (out of the 62) not already directly associated with angiogenesis for their function in the frog Xenopus laevis. Using whole mount in situ hybridization, the inventors first examined mRNA expression of the Xenopus orthologs of these genes. Consistent with hypothesis, the inventors found that six of the genes (orthologs of SOX13, RAB11B, HMHA1, TCEA3, TCEA1, and TBL1XR1) were robustly and predominantly expressed in the developing vasculature (e.g., see FIGS. 4B and 4C). These expression data suggested an overall discovery rate of angiogenesis-relevant genes by this phenolog of 39 times higher than random chance. (9 of 62 genes were angiogenesis-relevant, compared to the ˜1 in 267 expected from the frequency of known angiogenesis genes. The chances of this occurring at random are extremely low, p≦10⁻¹²). The inventors directly assayed the role of one of these genes, SOX13, in angiogenesis. SOX13 is a transcription factor that is known to regulate T lymphocyte differentiation [29]. The gene is expressed in mouse arterial walls [28], though it is also expressed in 30 of 45 assayed tissues in the NCBI Unigene Expressed Sequence Tag database. The Xenopus ortholog of SOX13 is Xenopus xSOX12, and this gene was found to be prominently expressed in the posterior cardinal veins, intersomitic veins, and developing heart, consistent with a role affecting developing vasculature (FIGS. 4B and 4C). The inventors knocked down xSOX12 expression using microinjection of morpholino antisense oligonucleotides (MO) and assayed for vasculature defects by in situ hybridization to the vasculature reporter genes Erg and XMsr (FIG. 4D). Knockdown of xSOX12 resulted in severe defects in vascular development, with morphant animals largely lacking intersomitic and posterior cardinal veins. By later stages, hemorrhaging was apparent in morphants due to the defective vasculature (FIG. 4E). Thus, xSOX12/SOX13 is a novel regulator of angiogenesis, discovered in the absence of any previous functional data linking it to angiogenesis, on the basis of orthology between mouse angiogenesis defects and yeast lovastatin sensitivity. Notably, these data also demonstrate that differentiation both of blood cells [29] and blood vessels are controlled by the same transcription factor.

The in vivo requirement for xSOX12/SOX13 in Xenopus was then confirmed in humans using siRNA-induced knockdown of SOX13 in an in vitro human umbilical vein endothelial cell angiogenesis assay (FIG. 4F). Thus, xSOX12/SOX13 is a novel regulator of angiogenesis, discovered in the absence of any previous functional data linking it to angiogenesis, on the basis of orthology between mouse angiogenesis defects and yeast lovastatin sensitivity. Notably, these data also demonstrate that differentiation both of blood cells [29] and blood vessels are controlled by the same transcription factor.

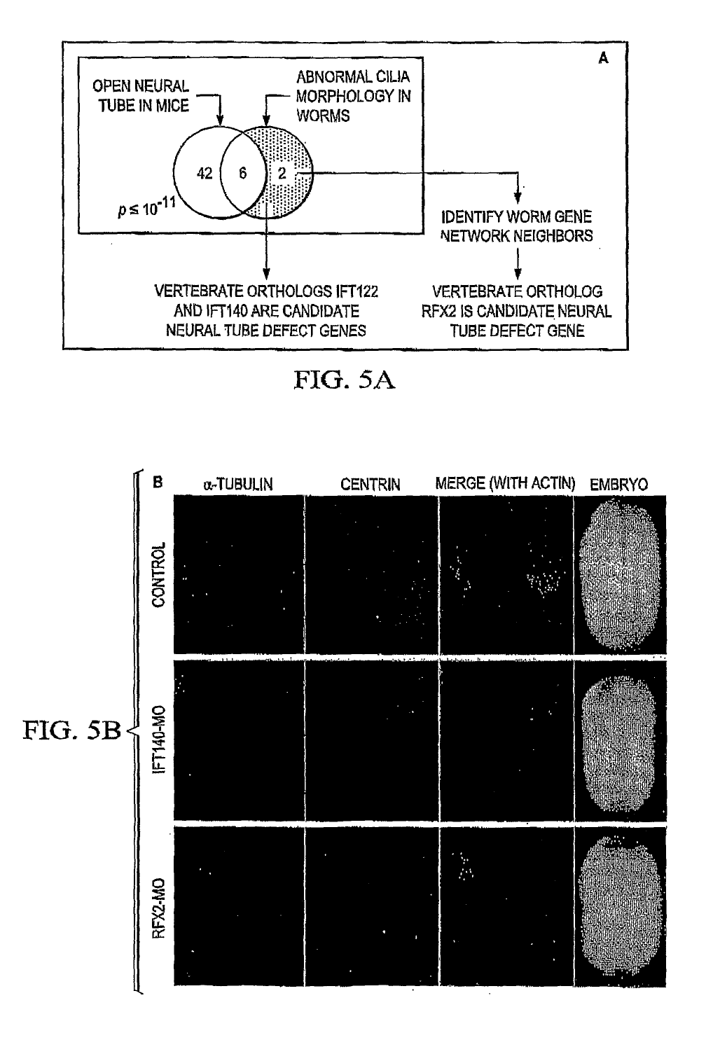

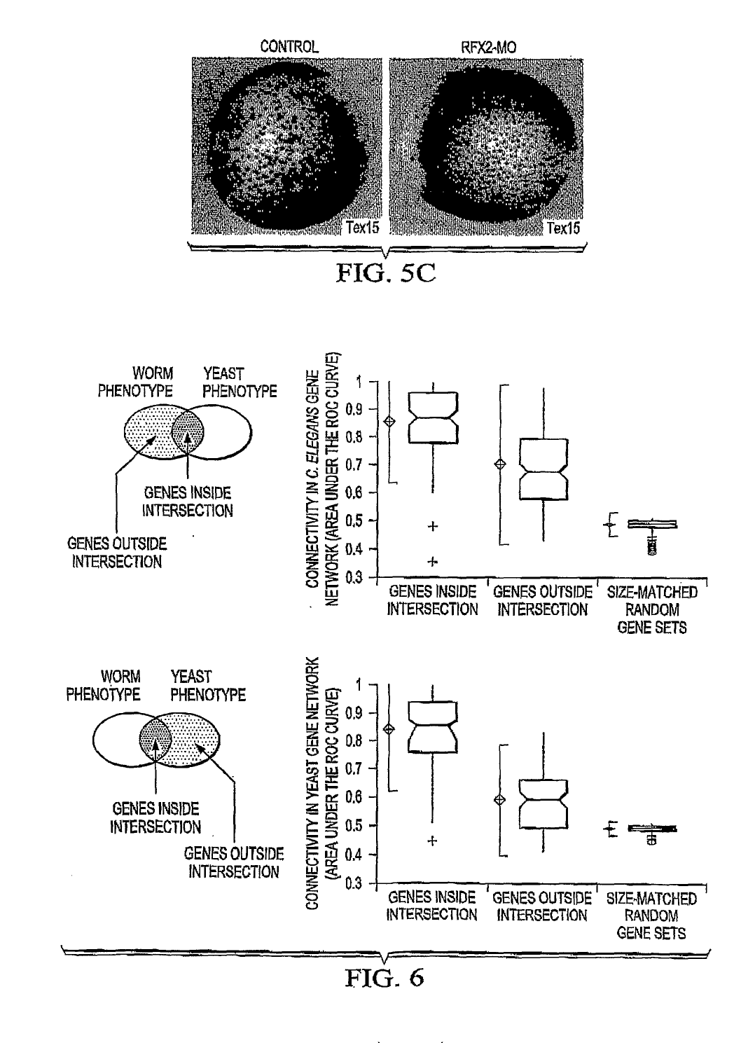

Given a phenolog for a human disease, any approach for associating more genes with the model organism trait, e.g., a genetic screen, will suggest new human disease gene candidates. The approach of the present invention and a phenolog between abnormal C. elegans cilia morphology and mouse neural tube defects—consistent with a known role for cilia in neural tube formation [30]—was used to identify new genes affecting vertebrate neural tube closure (FIG. 5A). Defects in neural tube closure are among the most common and debilitating human birth defects, afflicting nearly 1 in 1,000 live births worldwide [31], yet they have a complex genetic basis and knowledge of the underlying genes is still incomplete. The inventors first tested a direct prediction of the phenolog to confirm that the knockdown of the vertebrate intraflagellar transport gene IFT140 causes defective ciliogenesis and failure of neural tube closure in developing Xenopus embryos (FIG. 5B). The inventors then applied the emerging technique of network-guided genetics [32] to prioritize the transcription factor daf-19, a master regulator of worm ciliogenesis, as the gene most likely to show a similar effect (based on known genetic interactions to the cilia morphology defect genes). The inventors then knocked down the Xenopus ortholog of this gene, RFX2, and observed a defect in the developing neural tube at stage 20 (FIG. 5B), confirming RFX2's association with neural tube defects for the first time in a vertebrate. As RFX2 is a transcription factor, it might potentially control many downstream processes; analysis of an early marker of ciliated cell fate specification (TEX15 [33]) confirms that ciliated cells are intact in the RFX2 knockdown animals (FIG. 5C). Characterization of the precise defects of IFT140 and RFX2 knockdown in Xenopus shows normal deployment of basal bodies but marked

| | Phenotype₁ | | Phenotype₂ | n₁ | n₂ | k | p-value | PPV |
|---|---|---|---|---|---|---|---|---|
| Hs | cataracts | Mm | cataracts | 19 | 47 | 11 | 6 × 10⁻²⁴ | 1.00 |
| Hs | X-linked conductive | Mm | circling | 47 | 50 | 12 | 2 × 10⁻²⁰ | 1.00 |
| | deafness | | | | | | | |
| Hs | Bardet-Biedl | Mm | absent sperm flagella | 11 | 5 | 4 | 8 × 10⁻¹³ | 1.00 |
| | syndrome | | | | | | | |
| Mm | lymphoma | Sc | CANR mutator high | 14 | 11 | 6 | 1 × 10⁻¹¹ | 1.00 |
| Hs | Zellweger | Sc | reduced number of | 8 | 6 | 4 | 1 × 10⁻⁹ | 1.00 |
| | syndrome | | peroxisomes | | | | | |
| Hs | xeroderma | Sc | high UVC irradiation | 7 | 9 | 4 | 5 × 10⁻⁹ | 1.00 |
| | pigmentosum | | sensitivity | | | | | |
| Hs | susceptible to | Mm | abnormal social | 5 | 16 | 3 | 1 × 10⁻⁸ | 1.00 |
| | autism | | investigation | | | | | |
| Mm | abnormal heart | At | defective response to | 25 | 9 | 4 | 3 × 10⁻⁷ | 1.00 |
| | development | | red light | | | | | |
| Hs | Refsum disease | At | defective protein import | 4 | 5 | 2 | 1 × 10⁻⁵ | 1.00 |
| | | | into peroxisomal matrix | | | | | |
| Hs | susceptible to | Mm | abnormal circulating | 3 | 32 | 2 | 1 × 10⁻⁵ | 1.00 |
| | neural tube defects | | amino acid level | | | | | |
| Hs | porphyria | Sc | damnacanthal sensitive | 4 | 4 | 2 | 2 × 10⁻⁵ | 1.00 |
| Mm | abnormal heart | Ce | male tale morphology | 52 | 7 | 4 | 5 × 10⁻⁷ | 1.00 |
| | development | | abnormal | | | | | |
| Mm | pre-/peri-natal | Ce | sterile | 498 | 344 | 66 | 1 × 10⁻⁶ | 0.99 |
| | lethality | | | | | | | |
| Mm | absent posterior | At | shade avoidance defect | 2 | 4 | 2 | 1 × 10⁻⁶ | 0.99 |
| | semicircular canal | | | | | | | |
| Mm | spleen hypoplasia | Sc | uge (enlarged cells) | 5 | 16 | 3 | 3 × 10⁻⁶ | 0.99 |
| Mm | gastrointestinal | Ce | abnormal body wall | 6 | 3 | 2 | 4 × 10⁻⁶ | 0.98 |
| | hemorrhage | | muscle cell polarization | | | | | |
| Hs | achromatopsia | Ce | chemotaxis defective | 3 | 9 | 2 | 1 × 10⁻⁵ | 0.98 |
| Hs | mental retardation | At | cotyledon development | 13 | 5 | 2 | 1 × 10⁻⁴ | 0.98 |
| | | | defects | | | | | |
| Hs | congenital disorder | Sc | CID 604586 sensitive | 10 | 25 | 3 | 2 × 10⁻⁴ | 0.98 |
| | of glycosylation | | | | | | | |
| Hs | hemolytic anemia | Sc | hydroxyurea sensitive | 11 | 23 | 3 | 2 × 10⁻⁴ | 0.98 |
| Mm | abnormal olfactory | Ce | dauer constitutive | 7 | 4 | 2 | 1 × 10⁻⁵ | 0.97 |
| | neuron | | | | | | | |
| | morphology | | | | | | | |
| Hs | glycogen storage | Sc | glycogen storage | 3 | 20 | 2 | 2 × 10⁻⁴ | 0.97 |
| | disease | | reduced | | | | | |
| Hs | amyotrophic | Sc | increased resistance to | 2 | 34 | 2 | 2 × 10⁻⁴ | 0.97 |
| | lateral sclerosis | | wortmannin | | | | | |
| Mm | abnormal placenta | Sc | sorbitol sensitive | 8 | 14 | 3 | 1 × 10⁻⁵ | 0.96 |
| Mm | abnormal | Sc | cantharidin sensitive | 2 | 11 | 2 | 2 × 10⁻⁵ | 0.95 |
| | endocardium | | | | | | | |
| | morphology | | | | | | | |

reduction of cilia on multiciliated epithelial cells if either gene is knocked down (FIG. 5B). Given the good mechanistic and genetic agreement between Xenopus and mammalian neural tube closure [34], there is a high likelihood that defects in these genes are associated with human neural tube birth defects.

Other phenologs as discovered by the present invention, indicate equally suggestive disease models. In particular, a phenolog was observed between human X-linked breast/ovarian cancer and mutations leading to a highly elevated incidence of male progeny in C. elegans. Male C. elegans are determined by a single X chromosome, hermaphrodites by 2 copies; thus, X chromosome non-disjunction leads to higher frequencies of males [14]. Human breast/ovarian cancers can derive from a similar mechanism, e.g. as for sporadic basal-like breast cancers [15] and also increased incidence of breast cancers among Klinefelter's syndrome patients with an extra sex chromosome [35], supporting the notion that this phenology is identifying an useful disease model and suggesting that the human orthologs of the 13 additional genes associated with the worm trait might be reasonable candidate genes for involvement in these subsets of breast/ovarian cancers.

The present invention was used to examine and study three potential worm models for distinct aspects of neural tube development. Three serendipitous phenologies were discovered between distinct neural tube development in humans/mice and distinct developmental phenotypes of mutant C. elegans strains, along with their application to discover new neural tube defect genes. The details are presented below:

Example I: A phenology was observed between open neural tubes in mouse mutants with abnormal cilia morphology in worm mutants (48 mouse genes associated with NTDs, 8 worm genes associated with cilia defects, 3 shared, p≦10−5).

Example II: Two intriguing phenologies were observed between the human NTD-interrelated disorder holoprosencephaly (craniofacial defects, 4 genes) with worm lethality at the L1 larval stage (5 genes, 1 shared, p≦10⁻³) and a notched head (3 genes, 2 shared, p≦10⁻⁶). The 2 worm phenotypes share 1 gene, ceh-32, the worm ortholog of human SIX3, linked to holoprosencephaly [36]). In each case, a conserved subnetwork of genes was alternately repurposed to regulate NTDs in mammals and a different developmental pathway in C. elegans. Rather remarkably, a notched head in worms corresponds to human craniofacial developmental defects, as regards these pathways.

These case studies implicate the notch, ephrin, and ciliogenesis pathways in neural tube formation, consistent with prior observations (e.g., [37-39]). However, in each case, the phenologies suggest specific additional vertebrate orthologs of genes associated with the worm trait that are more likely to be associated with NTDs. The ciliogenesis case suggests that disrupting mammalian genes IFT122 and IFT140 should cause NTDs; they have not yet been disrupted in mice and their involvement in NT formation is unknown but reasonable. As described above, the inventors knocked down IFT140 gene expression in frogs and confirmed that this does induce a neural tube defect in a vertebrate. L1 larval lethality suggests human Jagged1 receptor and peregrin (orthologs of worm lag-2 and lin-49, whose mutations are L1 lethal) are candidate NTD genes. In fact, ˜30% of mutant Jagged1 mice do in fact show NTDs [40], although this was not yet annotated in databases, validating the approach of the present invention. The remaining genes are candidate effectors of NTDs. Genetic screens for more worm genes with these phenotypes might find more NTD-relevant genes.

Example III: Identification of two new genes affecting vertebrate neural tube closure, validated in the model vertebrate Xenopus laevis (frog). It was first confirmed that the vertebrate gene IFT140 (predicted by the worm phenology) caused failure of neural tube closure upon knockdown in developing Xenopus embryos. Given a phenolog for a human disease, any approach for associating more genes with the model organism trait, e.g., a genetic screen, will suggest new human disease gene candidates. The emerging technique of network-guided genetics [11, 32] was applied to prioritize the transcription factor daf-19, a master regulator of worm ciliagenesis [41], as likely to show a similar effect. The Xenopus ortholog of this gene, RFX2, was knocked down and a defect in the developing neural tube was observed, confirming RFX2's association with neural tube closure defects for the first time in a vertebrate. Characterization of the precise defect for IFT140 shows basal bodies are assembled, but cilia themselves are largely absent or malformed. Given the good agreement between Xenopus neural tube defects and mammalian ones [36, 42-49], these genes are thus highly likely to be associated with human neural tube birth defects.

Phenologs quantitatively test which known model organism (e.g., yeast/worm) mutant phenotypes best predict human/mouse neural tube defects and suggest specific candidate genes for further investigation.

Genes involved in phenologs show enhanced interconnectivity in gene networks, as shown in FIG. 6 for worm (top) and yeast (bottom) gene networks [32, 50]. All significant yeast-worm phenologs with at least 4 orthologs in both the ‘intersection’ and ‘non-intersection’ sets were tested for network connectivity, measured as the area under a receiver-operator characteristic (ROC) plot as described in [11], with values ranging from 0.5 (random network connectivity) to 1 (high network connectivity). Genes from phenolog intersections show significantly higher network connectivity than genes associated with a phenolog, but outside of the intersection, which in turn show significantly higher connectivity than size-matched random gene sets. Thus, phenologs capture subnetworks or network modules informative about a given phenotype pair, and carry predictive value for additional genes relevant to the phenotypes. At the left of each box-and-whisker plot, the center of the blue diamond indicates the mean AUC across phenologs, the top and bottom of the diamond indicate the 95% confidence interval, and the accompanying solid vertical line indicates ±2 standard deviations. The bottom, middle, and top horizontal lines of the box-and-whisker plots represent the first quartile, the median, and the third quartile of AUCs, respectively; whiskers indicate 1.5 times the interquartile range. Red plus signs represent individual outliers.

Plant models of human disease: The inventors further describe a plant model for the neural crest defects associated with Waardenburg syndrome, among others. The inventors have shown that SOX13 regulates angiogenesis, and SEC23IP is a likely Waardenburg gene. Phenologs reveal functionally coherent, evolutionarily conserved gene networks—many pre-dating the plant-animal divergence—capable of identifying candidate disease genes.

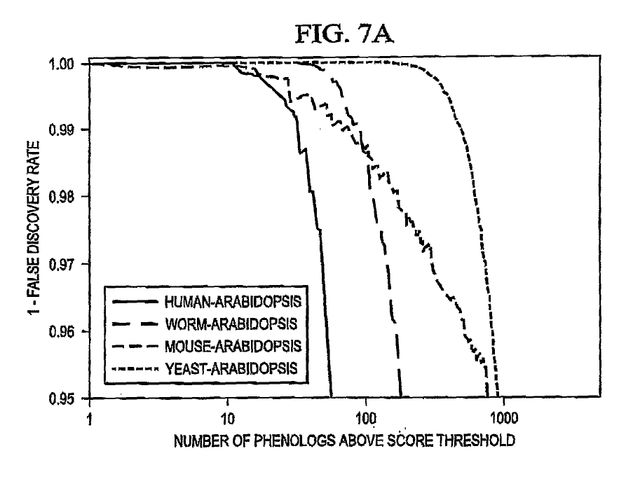

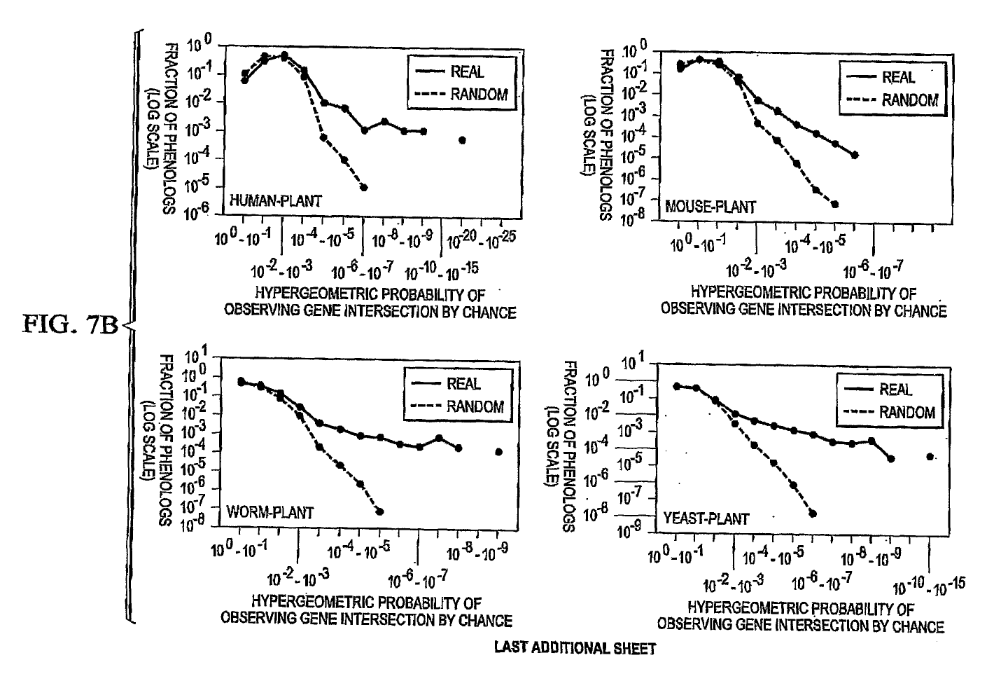

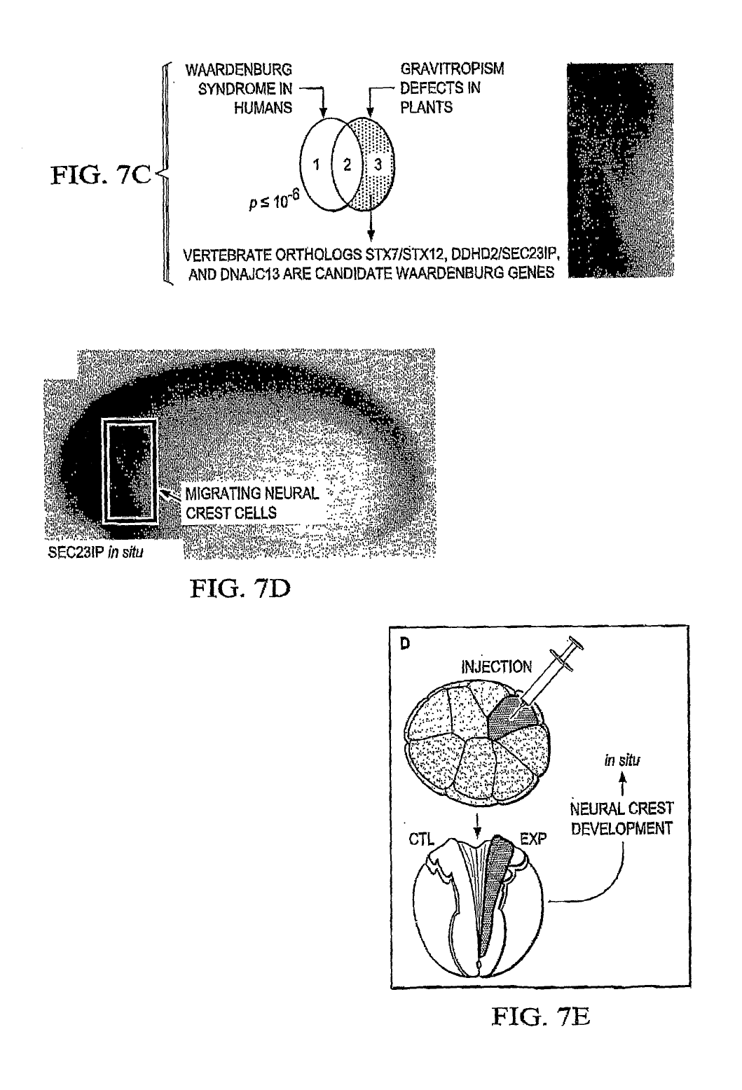

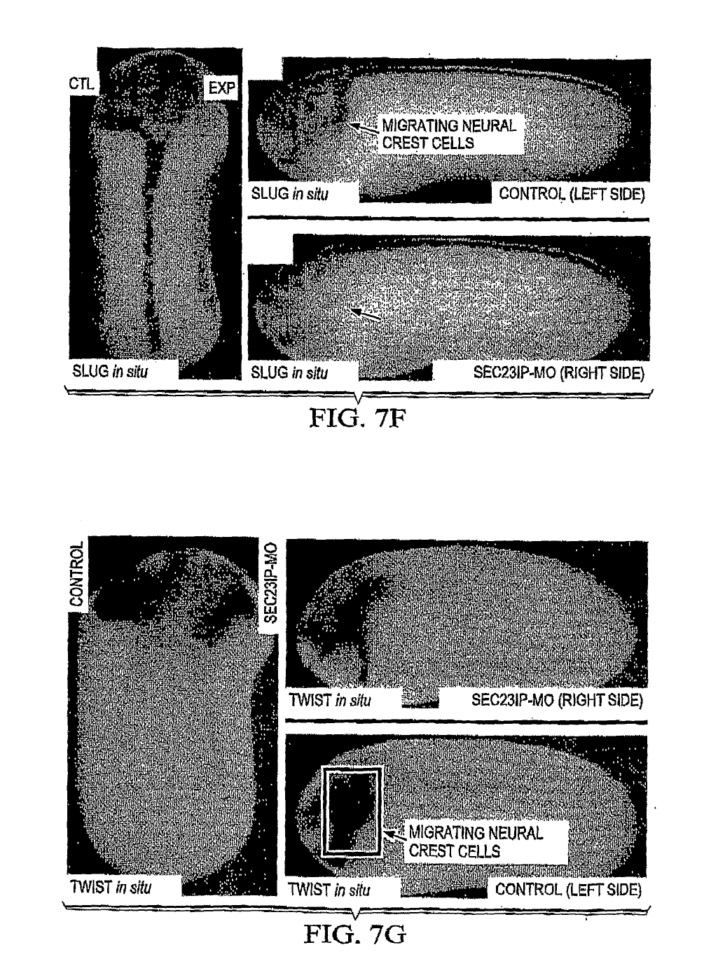

Phenologs provide a quantitative framework for identifying cases of extremely distant homology (“deep homology” [51]) of functionally coherent gene systems. This creates an opportunity to use very distantly related species as human disease models. The inventors tested this approach by systematically searching for plant models of human disease. The inventors collected 22,921 gene-phenotype associations—spanning 1,711 unique phenotypes—for the mustard plant Arabidopsis thaliana and analyzed these for phenologs with fungal and animal phenotypes. Hundreds of orthologous phenotypes were evident (FIGS. 7A and 7B), including 897, 733, 172, and 48 between Arabidopsis and yeast, mice, worms, and humans, respectively (5% FDR).

The human-plant phenologs suggest mappings between specific plant mutational phenotypes and diverse cancers, peroxisomal disorders such as Refsum disease and Zellweger syndrome, and a variety of birth defects (Table I). The inventors observed a striking plant human phenolog relating negative gravitropism defects to Waardenburg syndrome (FIG. 7C). This congenital syndrome stems from defects in the embryonic neural crest and is characterized by craniofacial dysmorphology, abnormal pigmentation, and hearing loss (in fact, it accounts for 2-5% of cases of human deafness [52]. In particular, this phenolog suggested that a set of three vesicle trafficking genes involved in directing plant growth in response to gravitational cues might also serve to direct neural crest cell migration and differentiation in developing animal embryos.

Encouragingly, one of the identified proteins (STX12) is known in mice to interact with the protein encoded by the pallid gene [53], whose mutational phenotypes include pigmentation and ear defects, consistent with Waardenberg syndrome [54]. The remaining 2 proteins had no support in the literature, and therefore the inventors evaluated the three mammalian orthologs of these genes by whole mount in situ hybridization in developing Xenopus embryos. The inventors found that SEC23IP was prominently expressed in migrating neural crest cells (FIG. 7D). The inventors used targeted microinjection of SEC23IP morpholinos to knock this gene down specifically in the neural crest. Unilateral targeting of SEC23IP MOs (FIG. 7E) resulted in marked defects in neural crest cell migration patterns specifically on the injected side (FIGS. 7F and 7G), thus confirming a role for this gene in neural crest cell development. Thus, SEC23IP is an excellent new candidate gene for Waardenburg syndrome, discovered on the basis of orthology of the disease to plant gravitropism defects. The success rate of 1 in 2 achieved by the inventors for finding Waardenburg-relevant genes represents a 550-fold improvement over the background rate of ˜1 in 1100 genes (p≦10⁻³). Notably, in spite of the extremely dissimilar associated phenotypes, the phenologs of the present invention can identify functionally coherent gene sets that predate the divergence of plants and animals.

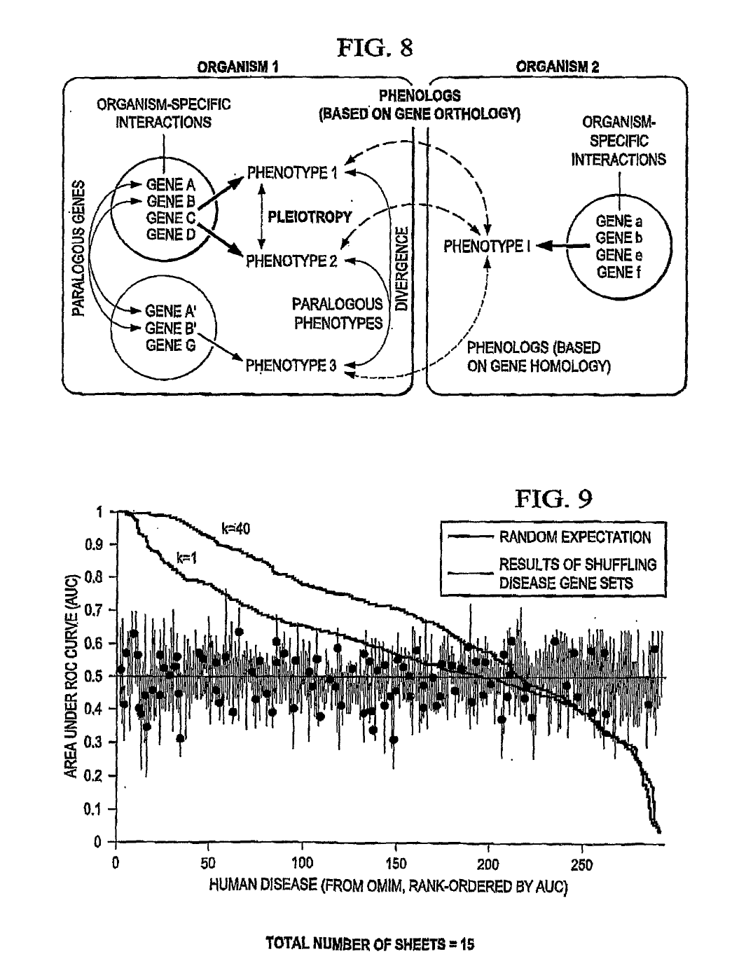

Much of the powerful conceptual framework established for gene sequence homology and orthology may also be applicable to phenologs. For example, equivalent phenotypes could be defined on the basis of homologous or paralogous, rather than orthologous, gene sequences, in this manner examining the divergence of phenotypic outcome of homologous systems (FIG. 8). Similarly, many of the algorithmic approaches used to identify orthologous genes might also be applied to the identification of phenologs. We explored this notion for one effective and easily automated approach to identify orthologous sequences, the bi-directional best hit (BBH) strategy. The BBH criterion holds that genes X and Y are orthologs if gene X is the most similar sequence to gene Y when searched genome-wide, provided the reciprocal search is also true. We adapted the BBH criterion to the identification of phenologs in order to identify the most equivalent phenotypes between two organisms from among those assayed, by asking if the phenotypes have the most significant gene overlaps with each other when searched against all phenotypes in their respective organisms. Such analysis gives a second criterion for identifying phenologs, useful for legitimate phenologs with poor p-values due to limited phenotypic data sets. Examples of such BBH phenologs are indicated in Table I.

The present inventors have further extended the phenolog concept described hereinabove to find human disease genes using a combination of phenotypes from other organisms, (i.e., not just using a single mutational phenotype). For the set of human genetic diseases, the present inventors predicted specific genes associated with each disease using 10-fold cross-validation, evaluating performance by standard ROC analysis (FIG. 9). The predictability was measured as the area under a ROC curve [11] and evaluated separately for each human genetic disease with ≧2 associated genes. An AUC of 1 indicates perfect prediction of known disease genes in a cross-validated test; an AUC of 0.5 indicates performance no better than chance. Error bars indicate 1st quartile, median, and 3rd quartile of predictions of shuffled disease gene sets from the k=1 test; score distributions from shuffling tests are similar for both k=1 and k=40 and center around AUC=0.5 as expected by chance. These tests employed an alternate formalism from that described hereinabove to discover significant phenologs, and were performed as described below:

A binary gene-disease association matrix was generated for each species, where the columns represent phenotypes. The rows in the human (or prediction) matrix each represent a single human gene; a true value in cell (i,j) indicates an association has been observed between gene i and disease j. Genes that have no identifiable orthologs in any species are excluded. False values in cells indicate that no association has been observed.

The rows in other species' matrices (the source matrices) are also described in terms of human genes: if the human gene has no ortholog in that species, the row is absent; but if the human gene has one or more orthologs in that species, a single row represents the whole set of orthologs. The presence of a true value in cell (i,j) indicates that a species-specific ortholog of human gene i is observed as associated with species-specific phenotype j. False values indicate no observed association.

Phenologs correspond to mappings between a prediction matrix column and the most similar source matrix column(s). In order to compute inter-column distances, a sub-matrix of the prediction matrix is generated, its rows limited to those shared by the source matrix. Treating each phenotype or disease as a column vector, a distance is computed between each of the phenotypes in the source matrix and each of the diseases in the prediction matrix.

As for the calculation of phenologs described above, the inventors defined the distance function as the hypergeometric probability of observing c or more common genes between source phenotype u and prediction disease v, with n total observations in one and m total observations in the other. The cardinality of the vectors u and v is N, the total number of human genes with orthologs in the source species. Thus, the probability is given by:

$${\sum }_{κ = c}^{min ( m , n )} \frac{( \begin{matrix}m \\ κ\end{matrix} ) ( \begin{matrix}N - m \\ n - κ\end{matrix} )}{( \begin{matrix}N \\ n\end{matrix} )} \qquad ( 1 )$$

For each prediction disease v, the inventors selected the source phenotype with the smallest distance as the top hit (best performing phenolog), then predicted genes' associations with the human disease according to their associations (true or false) with the source phenotype.

Predictive accuracy was evaluated by 10-fold cross-validation, omitting 10% of the prediction matrix rows for each of ten successive tests, and only evaluating predictions on the with-held 10% test set of genes, repeating for 10 unique test sets, and measuring true and false positive prediction rates using ROC analysis.

The inventors observed that those phenologs ranked just below the best (smallest distance) hit often provided additional valuable information about a disease. One simple method for integrating predictions across phenologs is to combine information from the k nearest neighbors (the top hit would be k=1). In some cases, distance to the k^{th} neighbor is equal to that of additional neighbors, representing a tie; in which case we included all neighbors tied with item k.

A simple weighting scheme was used to integrate evidence from the k (and tied with k^{th}) nearest neighbors, calculating a score for each human gene (row) as:

$$p ( gene ∈ disease \vert k disease phenologs ) = 1 - {\prod }_{i = 1}^{k} ( 1 - p ( gene ∈ disease \vert phenolog i is correct ) \times p ( phenolog i is correct ) ) \qquad ( 2 )$$

The inventors define the probability that the phenolog is correct (the final term) as one minus the hypergeometric probability given previously. For the probability of the gene being associated with the disease given that the phenolog i is correct, the inventors use the following empirical score: for a true source observation, as the ratio of the phenolog intersection (the size of set u∩v, defined above) to the size of set u; for a false source observation, as zero. Thus, while observations are binary (true or false), predictions are represented by scores (between 0 and 1), which are essentially weighted averages of the predictions of the k nearest orthologous phenotypes.

Null distributions were calculated by repeating the cross-validated analysis with ten randomizations of the prediction matrix. Randomization was accomplished by shuffling the true values in each prediction matrix column, in order to ensure that the phenotype gene set size distribution was maintained. Thus, considering for example a combination of 40 mutational phenotypes (from yeast, worms, plants, etc.) can dramatically improve the identification of human disease genes.

In principle, diverse computational methods can be employed to find the combinations of source matrix columns that best match each prediction matrix column, and thus which best identify candidate genes for the diseases or phenotypes corresponding to these columns.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

United States Patent Application No. 20090087846: Method for detecting large mutations and duplications using control amplification comparisons to paralogous genes.
U.S. Pat. No. 7,324,928: Method and system for determining phenotype from genotype.
1. Dryja, T. P., et al., Homozygosity of chromosome 13 in retinoblastoma. N Engl J Med, 1984. 310(9): p. 550-3.
2. Lu, X. and H. R. Horvitz, lin-35 and lin-53, two genes that antagonize a C. elegans Ras pathway, encode proteins similar to Rb and its binding protein RbAp48. Cell, 1998. 95(7): p. 981-91.
3. Fitch, W. M., Distinguishing homologous from analogous proteins. Syst Zool, 1970. 19(2): p. 99-113.
4. Darwin, C., On the Origin of Species by Means of Natural Selection, or the Preservation of Favoured Races in the Struggle for Life. 1859, London: John Murray.
5. Owen, R., Lectures on Comparative Anatomy and Physiology of the Invertebrate Animals. 1843, London: Longmans, Brown, Green and Longmans.
6. Online Mendelian Inheritance in Man (OMIM), McKusick-Nathans Institute of Genetic Medicine, Johns Hopkins University (Baltimore, Md.) and National Center for Biotechnology Information, National Library of Medicine (Bethesda, Md.).
7. Dwight, S. S., et al., Saccharomyces Genome Database (SGD) provides secondary gene annotation using the Gene Ontology (GO). Nucleic Acids Res, 2002. 30(1): p. 69-72.
8. Chen, N., et al., WormBase: a comprehensive data resource for Caenorhabditis biology and genomics. Nucleic Acids Res, 2005. 33(Database issue): p. D383-9.
9. Eppig, J. T., et al., The mouse genome database (MGD): new features facilitating a model system. Nucleic Acids Res, 2007. 35 (Database issue): p. D630-7.
10. Hillenmeyer, M. E., et al., The chemical genomic portrait of yeast: uncovering a phenotype for all genes. Science, 2008. 320(5874): p. 362-5.
11. McGary, K. L., I. Lee, and E. M. Marcotte, Broad network-based predictability of Saccharomyces cerevisiae gene loss-of-function phenotypes. Genome Biol, 2007. 8(12): p. R258.
12. Saito, T. L., et al., SCMD: Saccharomyces cerevisiae Morphological Database. Nucleic Acids Res, 2004. 32 Database issue: p. D319-22.
13. Remm, M., C. E. Storm, and E. L. Sonnhammer, Automatic clustering of orthologs and in-paralogs from pairwise species comparisons. J Mol Biol, 2001. 314(5): p. 1041-52.
14. Hodgkin, J., H. R. Horvitz, and S. Brenner, Nondisjunction Mutants of the Nematode CAENORHABDITIS ELEGANS. Genetics, 1979. 91(1): p. 67-94.
15. Richardson, A. L., et al., X chromosomal abnormalities in basal-like human breast cancer. Cancer Cell, 2006. 9(2): p. 121-32.
16. Scanlan, M. J., et al., Humoral immunity to human breast cancer: antigen definition and quantitative analysis of mRNA expression. Cancer Immun., 2001 1(4).
17. Dolphin, D., Porphyria, Vampires, and Werewolves: The Aetiology of European Metamorphosis Legends, in American Association for the Advancement of Science. 1985.
18. Macalpine, I. and R. Hunger, The Insanity of King George III: A Classic Case of Porphyria. British Medical Journal, 1966: p. 65-71.
19. Blacque, O. E. and M. R. Leroux, Bardet-Biedl syndrome: an emerging pathomechanism of intracellular transport. Cell Mol Life Sci, 2006. 63(18): p. 2145-61.
20. Feleszko, W., et al., Lovastatin and tumor necrosis factor-alpha exhibit potentiated antitumor effects against Ha-ras-transformed murine tumor via inhibition of tumor-induced angiogenesis. Int J Cancer, 1999. 81(4): p. 560-7.
21. Regan, C. P., et al., Erk5 null mice display multiple extraembryonic vascular and embryonic cardiovascular defects. Proc Natl Acad Sci USA, 2002. 99(14): p. 9248-53.
22. Hayashi, M., et al., Targeted deletion of BMK1/ERK5 in adult mice perturbs vascular integrity and leads to endothelial failure. J Clin Invest, 2004. 113(8): p. 1138-48.
23. Conway, R. E., et al., Prostate-specific membrane antigen regulates angiogenesis by modulating integrin signal transduction. Mol Cell Biol, 2006. 26(14): p. 5310-24.
24. Demierre, M. F., et al., Statins and cancer prevention. Nat Rev Cancer, 2005. 5(12): p. 930-42.
25. Potente, M., et al., SIRT1 controls endothelial angiogenic functions during vascular growth. Genes Dev, 2007. 21(20): p. 2644-58.
26. Ljubimov, A. V., et al., Involvement of protein kinase CK2 in angiogenesis and retinal neovascularization. Invest Ophthalmol Vis Sci, 2004. 45(12): p. 4583-91.
27. Shaw, G. C., et al., Mitoferrin is essential for erythroid iron assimilation. Nature, 2006. 440(7080): p. 96-100.
28. Roose, J., et al., High expression of the HMG box factor sox-13 in arterial walls during embryonic development. Nucleic Acids Res, 1998. 26(2): p. 469-76.
29. Melichar, H. J., et al., Science, 2007 315, 230.
30. Wallingford, J. B. Hum Mol Genet., 2006 15 Spec No 2, R227.
31. Botto, L. D., et al., N Engl J Med, 1999, 341, 1509.
32. Lee, I., et al., A single gene network accurately predicts phenotypic effects of gene perturbation in Caenorhabditis elegans. Nat Genet, 2008. 40(2): p. 181-8.
33. Hayes, J. M., et al., Dev Biol., 2007 312, 115.
34. Wallingford, J. B., Neural tube closure and neural tube defects: Studies in animal models reveal known knowns and known unknowns. American Journal of Medical Genetics, 2005. 135C(1): p. 59-68.
35. Kumar, S., et al., Agnogenic myeloid metaplasia associated with Klinefelter syndrome: a case report. Ann Hematol, 2002. 81(4): p. 215-8.
36. Wallis, D. E., et al., Mutations in the homeodomain of the human SIX3 gene cause holoprosencephaly. Nat Genet, 1999. 22(2): p. 196-8.
37. Akanuma, T., et al., Notch signaling is involved in nervous system formation in ascidian embryos. Dev Genes Evol, 2002. 212(10): p. 459-72.
38. Glazier, J. A., et al., Coordinated action of N-CAM, N-cadherin, EphA4, and ephrinB2 translates genetic prepatterns into structure during somitogenesis in chick. Curr Top Dev Biol, 2008. 81: p. 205-47.
39. Wu, J. I., et al., Targeted disruption of Mib2 causes exencephaly with a variable penetrance. Genesis, 2007. 45(11): p. 722-7.
40. Tsai, H., et al., The mouse slalom mutant demonstrates a role for Jagged1 in neuroepithelial patterning in the organ of Corti. Hum Mol Genet, 2001. 10(5): p. 507-12.
41. Swoboda, P., H. T. Adler, and J. H. Thomas, The RFX-type transcription factor DAF-19 regulates sensory neuron cilium formation in C. elegans. Mol Cell, 2000. 5(3): p. 411-21.
42. Haigo, S. L., et al., Shroom induces apical constriction and is required for hingepoint formation during neural tube closure. Curr Biol, 2003. 13(24): p. 2125-37.
43. Park, T. J., S. L. Haigo, and J. B. Wallingford, Ciliogenesis defects in embryos lacking inturned or fuzzy function are associated with failure of planar cell polarity and Hedgehog signaling. Nat Genet, 2006. 38(3): p. 303-11.
44. Wallingford, J. B. and R. M. Harland, Neural tube closure requires Dishevelled-dependent convergent extension of the midline Development, 2002. 129(24): p. 5815-25.
45. Hildebrand, J. D., Shroom regulates epithelial cell shape via the apical positioning of an actomyosin network. J Cell Sci, 2005. 118(Pt 22): p. 5191-203.
46. Huangfu, D. and K. V. Anderson, Cilia and Hedgehog responsiveness in the mouse. Proc Natl Acad Sci USA, 2005. 102(32): p. 11325-30.
47. Lanier, L. M., et al., Mena is required for neurulation and commissure formation. Neuron, 1999. 22(2): p. 313-25.
48. Roffers-Agarwal, J., et al., Enabled (Xena) regulates neural plate morphogenesis, apical constriction, and cellular adhesion required for neural tube closure in Xenopus. Dev Biol, 2008. 314(2): p. 393-403.
49. Wang, J., et al., Dishevelled genes mediate a conserved mammalian PCP pathway to regulate convergent extension during neurulation. Development, 2006. 133(9): p. 1767-78.
50. Lee, I., et al., PLoS ONE 2, 2007, e988.
51. N. Shubin, C. Tabin, S. Carroll, Nature 457, 818 (Feb. 12, 2009).
52. C. S. Nayak, G. Isaacson, Ann Otol Rhinol Laryngol 112, 817 (September, 2003).
53. L. Huang, Y. M. Kuo, J. Gitschier, Nat Genet 23, 329 (November, 1999).
54. L. L. Theriault, L. S. Hurley, Dev Biol 23, 261 (October, 1970).

1. A method of identifying one or more candidate genes for a trait, a phenotype, or a disease of interest comprising the steps of:
identifying one or more orthologous genes involving the trait, the phenotype, or the disease of interest by:
comparing a first set of genes associated with a first phenotype in a first organism with a second set of genes associated with a second phenotype in a second organism, wherein the first and second phenotypes do not have one or more common characteristics, and the second phenotype in the second organism is selected such that at least one gene belongs to both the first and the second set of genes in the first and the second organisms respectively; and
selecting from the second organism one or more candidate genes from the second set of genes associated with the second phenotype other than the genes known to overlap between the first and the second phenotypes as the candidate genes for belonging to the first phenotype in the first organism.

2. The method of claim 1, further comprising the step of modifying the expression of one or more candidate genes in the first organism to confirm its equivalency to the one or more candidate genes of the second phenotype of the second organism.

3. The method of claim 1, wherein the first organism is selected from group comprising a human, a mouse, a worm, an amphibian, a fish, a fungus, an animal, and a plant.

4. The method of claim 1, wherein the second organism is selected from a group comprising a human, a mouse, a worm, an amphibian, a fish, a fungus, an animal, and a plant.

5. The method of claim 1, wherein the two comparison gene sets compares a mammalian gene set with a yeast cell gene set, a worm cell gene set, a fish gene set, an amphibian gene set, a plant gene set, or a different mammalian gene set.

6. The method of claim 1, the two comparison gene sets compares a yeast gene set with a mammalian gene set, a worm cell set, a fish set, an amphibian set, a plant set, or a different yeast gene set.

7. The method of claim 1, wherein the one or more candidate genes comprises genes previously unknown to have an association with a human phenotype.

8. The method of claim 1, wherein the first dataset comprises a human disease gene set, and the second dataset comprises a gene set selected from a group comprising a yeast, a fungus, a worm, a mouse, an animal, another mammal, an amphibian, a plant, and a fish.

9. The method of claim 1, wherein the step of selecting the one or more candidate genes is defined further as comprising measuring the p (overlap>k|n,m,N) for each disease-phenotype pair.

10. The method of claim 1, wherein the step of identifying the second phenotype and the second set of genes or both is defined further as comprising the selection of all significant candidate genes by permutations or reciprocal best hits.

11. The method of claim 1, wherein the step of identifying the second phenotype, the second set of genes or both is defined further as comprising the step of calculating a confidence value for each potential candidate gene based on the hypergeometric probability of observing at least that many shared orthologous genes by random chance.

12. The method of claim 1, further comprising the step of identifying a new disease model system based on the one or more candidate genes.

13. The method of claim 1, further comprising the step of testing the first organism for a disease phenotype.

14. A method of identifying a novel disease model system comprising:
comparing a first mutant genotype database of a first organism with a first phenotype with a second mutant genotype database of a second organism with a second phenotype, wherein the first and the second organisms are different, wherein the first and second mutant genotypes have one or more common characteristics;
selecting in the first organism one or more first phenotype genes, other than the first mutant genotype from the first mutant genotype database, that overlap with one or more second phenotype genes, other than the second mutant genotype from the second mutant genotype database;
identifying if the second organism has one or more second phenotype genes that are equivalent to the first phenotype genes from the first organism from the second mutant genotype database; and
testing the second organism for the disease phenotype.

15. The method of claim 14, further comprising the step of modifying the expression of one or more candidate genes in the second organism to confirm its equivalency to the one or more candidate genes of the first phenotype of the first organism.

16. The method of claim 14, wherein the first organism is selected from a group comprising a human, a mouse, a worm, an amphibian, a fish, a fungus, an animal, and a plant and the second organism selected from a group comprising a human, a mouse, a worm, an amphibian, a fish, a fungus, an animal, and a plant.

17. (canceled)

18. The method of claim 14, wherein the first set of genes is selected from the group consisting of a mammalian gene set, a yeast cell gene set, a worm gene set, a fish gene set, an amphibian gene set, and a plant gene set; and the second set of genes is selected from the group consisting of a different mammalian gene set, a yeast cell gene set, a worm gene set, a fish gene set, an amphibian gene set, and a plant gene set.

19. The method of claim 14, wherein (1) the first set of genes is a human gene set and the second set of genes is selected from the group consisting of a non-human mammalian gene set, a yeast gene set, a worm gene set, a fish gene set, an amphibian gene set, and a plant gene set or (2) first set of genes is a yeast gene set and the second set of genes is selected from the group consisting of a mammalian gene set, a different yeast gene set, a worm gene set, a fish gene set, an amphibian gene set, and a plant gene set or (3) the first set of genes is a plant gene set and the second set of genes is selected from the group consisting of a mammalian gene set, a yeast gene set, a worm gene set, a fish gene set, an amphibian gene set, and a different plant gene set.

20.-22. (canceled)

23. The method of claim 14, wherein the first dataset comprises a human disease gene set, and the second dataset comprises a gene set selected from a group comprising a yeast, a fungus, a worm, a mouse, an animal, another mammal, an amphibian, a plant, and a fish.

24. The method of claim 14, wherein the step of selecting the one or more candidate genes is defined further as comprising measuring the p (overlap>k|n, m, N) for each disease-phenotype pair.

25. The method of claim 14, wherein the step of identifying the second phenotype genes is defined further as comprising the selection of all significant candidate genes by permutations or reciprocal best hits.

26. The method of claim 14, wherein the step of identifying the second phenotype genes is defined further as comprising the step of calculating a confidence value for each candidate gene based on the hypergeometric probability of observing at least that many shared orthologous genes by random chance.

27. The method of claim 14, further comprising the step of identifying a new disease model system based on the one or more candidate genes.

28. The method of claim 14, further comprising the step of testing the second organism for the disease phenotype.

29.-35. (canceled)

36. A method of identifying one or more disease genes in a human species by using a combination of phenotypes from one or more comparison non-human species comprising the steps of:
identifying and storing in an orthologous gene dataset of one or more orthologous genes of the human species in the one or more additional species by:
creating a gene-disease association prediction matrix for the human species comprising one or more columns, rows, and cells, wherein the columns comprise one or more human species diseases and the rows comprise one or more human species genes, wherein any genes not having any identifiable orthologous genes in the comparison species are excluded, and wherein the value of cells correspond to associations between human species genes with human species diseases; and
creating a gene-phenotype association source matrix for each of the one or more comparison species comprising one or more columns, rows, and cells, wherein the columns comprise one or more comparison species phenotypes or diseases and the rows comprise one or more human species genes which have orthologous genes in the one or more comparison species, and wherein values of cells correspond to associations between comparison species phenotypes or diseases with comparison species orthologous genes of human species genes; and
determining one or more phenologs by a calculation of an inter-column distance between each of the phenotypes in the source matrix and a disease in the prediction matrix, wherein the determination is based on a hypergeometric probability calculation or a similar technique and storing the phenologs in a phenolog dataset; and
identifying one or more human species disease-gene associations based on associations in a selection or combination of one or more phenotypes in the source matrix with a smallest inter-column distance with the column corresponding to the disease in the prediction matrix.

37. The method of claim 36, wherein the one or more non-human species are selected from the group consisting of a yeast, a mouse, an amphibian, a plant, a fish, a worm or another mammal.

38. The method of claim 36, further comprising the step of evaluating the accuracy of the prediction results by one or more cross-validating techniques.
